(19) United States
(12) Patent Application Publication
(10) Pub. No.: US 2005/0162624 A1
(43) Pub. Date: Jul. 28, 2005

(54) Projector and zoom adjustment method

(75) Inventor: Noriaki Miyasaka, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/023,405

(22) Filed: Dec. 29, 2004

(30) Foreign Application Priority Data
Jan. 8, 2004 (JP) 2004-003200

(51) Int. Cl. G21K 1/12; G01N 23/00; G03B 3/00

(52) U.S. Cl. 353/101

(57) ABSTRACT

Traditionally, in the case in which an image is projected onto an object of projection not equipped with frame marking edges, markers have had to be attached to the object of projection each time in order to automatically adjust the size of the projection region to which the image light is projected, which was cumbersome. Thus, in the present invention, in projecting the test pattern images onto the object of projection, the zoom projection lens is adjusted to enlarge the size of the projection region gradually, and the projection region is imaged each time. After the vertex of the object of projection matches the edge of the object of projection, when the projection region becomes forced out from the area of the object of projection, a part of the contour of the test pattern images projected within the imaged image matches a part of the edges of the object of projection. Therefore, the contours of the test pattern images projected within the projected images are compared before and after the enlargement. In the case in which there is a consistent portion, it is determined that the projection region has become forced out from the area of the object of projection, and an attempt is made to restore the size of the projection region to the previous size before the enlargement.

### BACKGROUND OF THE INVENTION

1. Field of the Invention

The present invention relates to a projector, especially to a technology which automatically zooms onto a region to which image light is projected in consideration of the size of the object of projection.

2. Description of the Related Art

Generally speaking, in utilizing a projector which projects an image onto the object of projection as image light, adjustment is conducted in a manner in which the region (hereafter, referred to as the “projection region) to which the image light is projected becomes completely accommodated within the object of projection, and in which the projected image that is projected (hereafter, referred to as the “projected image”) is displayed as large as possible. In addition, in many cases, such adjustment is conducted by means of adjusting the positions of the lens equipped in the projector as the projection lens (hereafter, referred to as the “zoom adjustment”). In particular regards to portable projectors, it is possible for the distance from the object of projection to become varied every time they are set up; therefore, it has been necessary for the above-stated zoom adjustment to be conducted each time, which has been cumbersome. Hence, traditionally, several proposals in regards to projector structures and zoom adjustment methods which utilize the corresponding projectors have been made for the purpose of simplifying zoom adjustment.

For example, as disclosed in Japanese Patent Laid-Open Gazette No. 10-333088, when the object of projection is a screen, a method which utilizes a projector equipped with a camera for imaging the screen, as well as a square screen marked with cross-shaped screen markers at the four corners, has been proposed.

Specifically, first of all, similarly to the screen, square test pattern images marked with crossed-shaped image markers indicating the four corners are projected from the projector onto the screen, and the screen in this state becomes imaged. In the case in which the projection region is accommodated completely within the screen, the imaged image contains not only the screen markers on the screen, but also the image markers displayed on the screen. Thus, the distances between the screen markers on the imaged image, and between the image markers, are calculated, and these distances are compared.

In the case in which the distance between the image markers is smaller than the distance between the screen markers, the projection zoom lens is shifted to the wide-angle side so that the projection region is adjusted to be larger; in the case in which the distance between the image markers is larger than the distance between the screen markers, the projection zoom lens is shifted to the telescopic side so that the projection region is adjusted to be smaller.

In the traditional technology stated above, in order to automatically adjust the size of the projection region in consideration of the object of projection, it has been necessary to attach edge-indicating markers onto the screen functioning as the object of projection. Incidentally, in some cases, a portable white board has been utilized as the object of projection, instead of a screen. In such cases, because such white board does not possess edge-indicating markers, when utilizing such white board as the object of projection and attempting to conduct the traditional method of zoom adjustment stated above, markers have had to be attached to the white board every time the projector has been used, which has constituted required labor on the side of the users. Moreover, such markers may be attached to the white board on a normal basis; however, in such cases, when writing on the board, such markers have impeded writing, which is problematic.

### SUMMARY OF THE INVENTION

The present invention was developed in order to solve the above-stated problems. The purpose of the present invention is to provide an automatic method of zoom adjustment in which the projection region becomes accommodated within the object of projection without requiring the attachment of markers, etc. onto the object of projection, and in which the projected image displayed onto the object of projection is rendered sufficiently large for the object of projection.

In order to attain at least part of the above and the other related objects, the present invention is directed to a first projector for projecting image light onto an object of projection to display an image. The first projector includes: a zoom lens capable of changing the size of the projection region onto which the image light is projected; a drive unit for driving the zoom lens; an imaging unit that images at least the projection region; and a control unit; wherein the control unit controls the drive unit to drive the zoom lens and change the size of the projection region, and in an image obtained by imaging through means of the imaging unit, successively compares the contours of the projection region accommodated within the object of projection before and after the size of the projection region changes; extracts as unchanged portion a portion that match before and after the size change; and in the event that a feature point of the projection region reaches the unchanged portion, or the distance to the unchanged portion falls below a predetermined value, halts driving of the zoom lens so that the projection region assumes the size immediately previous.

The control unit controls the drive unit to drive the zoom lens and change the size of the projection region. For example, when the projection region is enlarged gradually, as long as the projection region is accommodated within the object of projection, when the contours of the projection regions are compared before and after enlargement, they do not match each other. On the other hand, when the projection region becomes forced out from the area of the object of projection, on the border with the un-accommodated portion, as the projection region extends out, a portion of the contour of the projection region accommodated within the object of projection extends along with the edge of this object of projection. Therefore, before and after enlargement, a comparison of the contours of the projection regions accommodated within the object of projection determines that the portions extending along the edge of the projection edge match each other.

Therefore, when imaging the projection region by means of the imaging unit, and comparing the contours of the projection regions accommodated within the object of projection in the imaged image, the matching portions can be extracted as the unchanged portion.

Subsequently, when the projection region is enlarged, and the feature point of the projection region exceeds the edge of the object of projection, the feature point of the projection region reaches the unchanged portion. At this time, by terminating zoom lens driving in such a manner that the size of the projection region becomes that of the immediately previous projection region, the zoom adjustment can be stopped in a state in which the feature points of the projection region match the edge of the object of projection. As a result, for example, if the feature point of the projection region is the vertex of the projection region, the image light is projected from a direction other than the right front direction of the object of projection (so to speak, “high-angle projection”), and the shape of the projection region is distorted so as to be a trapezium. In this case, when zoom adjustment is stopped in a state in which the second vertex point matches the edge of the object of projection, the entire portion of one side of the projection region becomes forced out from the area of the object of projection. Subsequently, by correcting the trapezoidal distortion (so to speak, “keystone correction”), it becomes possible to accommodate the projection region within the object of projection, and to cause the projected image to become displayed onto the object of projection at a size sufficiently large for the object of projection.

Furthermore, the operation for zoom lens driving may be stopped in such a manner that the size of the projection region becomes that of the immediately previous projection region, not at the time at which the projection region becomes enlarged and the feature point of the projection region reaches the unchanged portion, but rather at the time at which the distance between the feature point and the unchanged portion in the projection region becomes less than a predetermined value. Even with this new timing, by means of subsequent keystone correction, it becomes possible to accommodate the projection region within the object of projection, and to render the projected image to become displayed onto the object of projection at a size sufficiently large for the object of projection.

As stated above, because the size of the projection region is adjusted based on the imaged image obtained before and after changing the size of the projection region, it becomes possible to accommodate the projection region within the object of projection without attaching the markers onto the object of projection, and to render the projected image to become displayed onto the object of projection at a size sufficiently large for the object of projection.

Furthermore, when the control unit changes the size of the projection region, it may be designed in a manner so that the size of the projection region becomes enlarged gradually.

Moreover, the present invention is directed to a second projector for projecting image light onto an object of projection to display an image. The second projector includes: a zoom lens capable of changing the size of the projection region onto which the image light is projected; a drive unit for driving the zoom lens; an imaging unit that images at least the projection region; and a control unit; wherein the control unit controls the drive unit to drive the zoom lens and change the size of the projection region in a manner so that the size is enlarged gradually, and in the event that an entire portion of one side of the projection region no longer appears within an image obtained through imaging by means of the imaging unit, halts driving of the zoom lens so that the projection region assumes the size immediately previous.

The control unit controls the zoom lens to drive the zoom lens and change the size of the projection region so that it gradually becomes enlarged. When either one of the vertex points of the projection region exceeds the edge of the object of projection, and the entire portion of one side of the projection region becomes completely forced out from the area of the object of projection, the entire side of the projection region does not appear within the image obtained through imaging by means of the imaging unit.

At this time, by halting the zoom lens drive so that it is the size of the immediately previous projection region, the zoom adjustment can be stopped in a state in which the entire side of the projection region becomes forced out from the area of the object of projection. As a result, by subsequently conducting keystone correction, it becomes possible to accommodate the projection region within the object of projection, and to render the projected image to become displayed onto the object of projection at a size sufficiently large for the object of projection.

Therefore, because the size of the projection region is adjusted based on the imaged image obtained before and after changing the size of the projection region, it becomes possible to accommodate the projection region within the object of projection without attaching markers onto the object of projection, and to render the projected image to become displayed onto the object of projection at a size sufficiently large for the object of projection.

Moreover, the present invention is directed to a third projector for projecting image light onto an object of projection to display an image. The third projector includes: a zoom lens capable of changing the size of the projection region onto which the image light is projected; a drive unit for driving the zoom lens; an imaging unit that images at least the projection region; and a control unit; wherein the control unit controls the drive unit to drive the zoom lens and change the size of the projection region in a manner so that the size is enlarged gradually, and in the event that a feature point of the projection region no longer appears within an image obtained through imaging by means of the imaging unit, halts driving of the zoom lens so that the projection region assumes the size immediately previous.

The control unit controls the zoom lens to drive the zoom lens and change the size of the projection region so that it gradually becomes enlarged. When the feature point of the projection region exceeds the edge of the object of projection and becomes forced out from the area of the object of projection, the feature point does not appear within the imaged image obtained through imaging by means of the imaging unit.

At this time, by halting the zoom lens drive so that it is the size of the immediately previous projection region, the zoom adjustment can be stopped in a state in which the feature point of the projection region matches the edge of the object of projection. For example, if the feature point of the projection region is the vertex of the projection region, when the zoom adjustment is stopped in a state in which the first vertex point of the projection region matches the edge of the object of projection, the projection region becomes accommodated within the object of projection without fail.

Therefore, because the size of the projection region is adjusted based on the imaged image obtained before and after the size of the projection region is changed, it becomes possible to accommodate the projection region within the object of projection without attaching markers onto the object of projection, and to render the projected image to become displayed onto the object of projection at a size sufficiently large for the object of projection.

Moreover, the present invention is directed to a fourth projector for projecting image light onto an object of projection to display an image. The fourth projector includes: a zoom lens capable of changing the size of the projection region onto which the image light is projected; a drive unit for driving the zoom lens; an imaging unit that images at least the projection region; and a control unit; wherein the control unit controls the drive unit to drive the zoom lens and change the size of the projection region in a manner so that the size is gradually reduced, and in the event that a feature point of the projection region appears within an image obtained through imaging by means of the imaging unit, halts driving of the zoom lens.

The control unit controls the zoom lens to drive the zoom lens change the size of the projection region so that it gradually becomes reduced. When the state is changed from one in which the feature point of the projection region is forced out from the area of the object of projection to one in which the feature point of the projection region matches the edge of the object of projection, the feature point appears for the first time in the imaged image obtained by imaging through the imaging unit.

At this time, by halting the zoom lens drive, the zoom adjustment can be stopped in a state in which the feature point of the projection region matches the edge of the object of projection. For example, if the feature point of the projection region is the vertex of the projection region, when the zoom adjustment is stopped in a state in which the fourth vertex point of the projection region matches the edge of the object of projection, the projection region becomes accommodated within the object of projection without fail.

Therefore, because the size of the projection region is adjusted based on the imaged image obtained before and after changing the size of the projection region, it becomes possible to accommodate the projection region within the object of projection without attaching markers onto the object of projection, and to render the projected image to become displayed onto the object of projection at a size sufficiently large for the object of projection.

Moreover, the present invention is directed to a fifth projector for projecting image light onto an object of projection to display an image. The fifth projector includes: a zoom lens capable of changing the size of the projection region onto which the image light is projected; a drive unit for driving the zoom lens; an imaging unit that images at least the projection region; and a control unit; wherein the control unit controls the drive unit to drive the zoom lens and change the size of the projection region in a manner so that the size is gradually enlarged from the smallest size, and in an image obtained through imaging by means of the imaging unit, successively compares the contours of the projection region accommodated within the object of projection before and after the size of the projection region is changed; and in the event that a portion that match before and after the size change is extracted, halts driving of the zoom lens so that the projection region assumes the size immediately previous.

The control unit controls the zoom lens to drive the zoom lens and change the size of the projection region so that it gradually becomes enlarged from the smallest size. In the case of gradually enlarging the projection region, as long as the projection region is accommodated within the object of projection, a comparison of the contours of the projection regions determines inconsistencies before and after enlargement.

On the other hand, when the projection region becomes forced out from the area of the object of projection, on the border with the un-accommodated portion, as the projection region extends out, a portion of the contour of the projection region accommodated within the object of projection extends along with the edge of this object of projection. Therefore, before and after enlargement, a comparison of the contours of the projection regions accommodated within the object of projection determines that the portions extending along the edge of the projection edge match each other.

At this stage, in regards to the moment at which the contours of the projection regions accommodated within the object of projection extending along the object of projection match each other, prior and subsequent to enlargement, this moment occurs immediately after the first vertex of the projection region exceeds the edge of the object of projection.

Therefore, when the projection region is imaged through the imaging unit, and the contours of the projection region accommodated within the object of projection are consecutively compared within the imaged image before and after enlargement, the matching portions can be extracted for the first time immediately after the first vertex of the projection region exceeds the edge of the object of projection. In addition, at this time, by halting the zoom lens drive in a manner so that the size of the projection region is that of the immediately previous projection region, the zoom adjustment can be stopped in a state in which the first vertex of the projection region matches the edge of the object of projection.

Therefore, because the size of the projection region is adjusted based on the imaged image obtained before and after the size of the projection region is changed, it becomes possible to accommodate the projection region within the object of projection without attaching markers onto the object of projection, and to render the projected image to become displayed onto the object of projection at a size sufficiently large for the object of projection.

Furthermore, in the present invention, the feature point of the projection region is preferably the vertex of the projection region.

Moreover, in the present invention, when, among the vertexes of the projection region, the first vertex reaches the unchanged portion, and the second vertex subsequently reaches the unchanged portion, the feature point of the projection region may be the second vertex.

With the arrangement stated above, when the image light is projected through high-angle projection, it becomes possible to stop the zoom adjustment in a state in which the first vertex of the projection region exceeds the edge of the object of projection, and the second vertex of the projection region matches the edge of the object of projection; namely in a state in which the entire portion of one side of the projection region becomes completely forced out from the area of the object of projection. By subsequently conducting keystone correction, it becomes possible to accommodate the projection region within the object of projection, and to render the projected image to become displayed onto the object of projection at a size sufficiently large for the object of projection.

Furthermore, the embodiment of the present invention is not limited to aspects of inventing devices such as the above-stated projectors; it can be also embodied in the aspect of inventing methods such as zoom adjustment.

### BRIEF DESCRIPTION OF THE DRAWINGS

FIG. 1 is an illustration showing a schematic structure of the Projector 100 in a first embodiment of the present invention.

FIG. 2 is a flow chart showing the zoom adjustment procedure in the first embodiment.

FIGS. 3(A1) through (E) are illustrations showing the state in which the image light is projected, and the image after various treatments have been conducted to the imaged image in the first embodiment.

FIGS. 4(A) and (B) are illustrations showing the state in which the image light is projected before and after keystone correction.

FIG. 5 is a flow chart showing the zoom adjustment procedure in a second embodiment of the present invention.

FIGS. 6(A1) through (G) are illustrations showing the state in which the image light is projected, and the image after various treatments have been conducted to the imaged image in the second embodiment.

FIGS. 7(A) through (E) are illustrations showing the vertex block detection treatment in the second embodiment.

FIGS. 8(A) through (C) are illustrations showing the test pattern images and the imaged images on the white board W in modification example #1.

FIGS. 9(A) through (C) are illustrations showing the test pattern images and the imaged images on the white board W in modification example #2.

FIGS. 10(A) through (C) are illustrations showing the imaged image on the white board W in the case of zooming gradually towards the telescopic side in modification example #2.

### DESCRIPTION OF THE PREFERRED EMBODIMENTS

One mode of carrying. out the invention is discussed below as a preferred embodiment in the following sequence.

A. Embodiment

A1. First Embodiment:
A1-1. Structure of the zoom device:
A1-2. Specific actions of the zoom adjustment:
A1-3. Effects of the first embodiment:
   A2. Second Embodiment:
A2-1. Purpose of the zoom adjustment:
A2-2. Specific actions of the zoom adjustment:
A2-3. Detailed actions of the vertex block detection treatment:
A2-4. Effects of the second embodiment:
   A. Modification Examples:

B1. Modification Example #1:

B2. Modification Example #2:

B3. Modification Example #3:

B4. Modification Example #4:

B5. Modification Example #5:

B6. Modification Example #6:

B7. Modification Example #7:

B8. Modification Example #8:

A. Embodiment:

A1. First Embodiment:

A1-1. Structure of the zoom device:

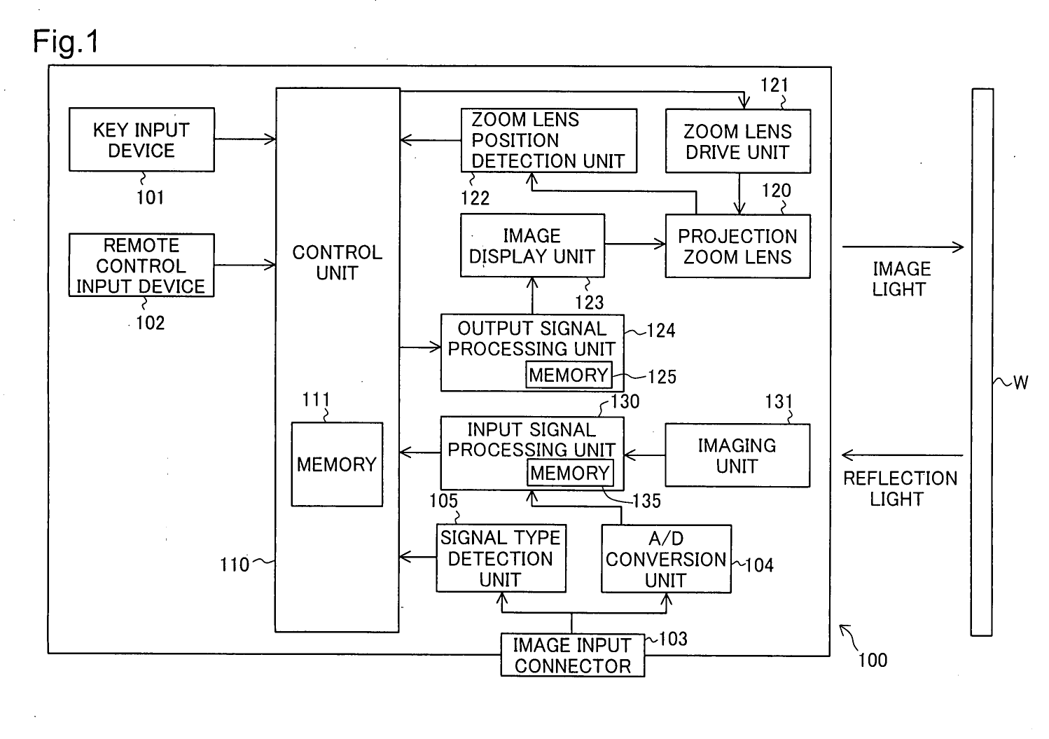

First of all, the schematic structure of the projector in one embodiment of the present invention is explained, utilizing FIG. 1 as a reference.

FIG. 1 is an illustration showing a schematic structure of the Projector 100 in a first embodiment of the present invention As shown in FIG. 1, the Projector 100 is equipped with a Key Input Unit 101 and a Remote Control Input Unit 102, both for inputting instructions from the user, an Image Input Connector 103 for processing the input images, a A/D Conversion Unit 104, a Signal Type Detection Unit 105, an Input Signal Processing Unit 130, an Imaging Unit 131, and a Projection Zoom Lens 120 for processing the images to be output, and a Zoom Lens Drive Unit 121, a Zoom Lens Position Detection Unit 122, an Image Display Unit 123, an Output Signal Processing Unit 124, and a Control Unit 110 for controlling the above-stated function units.

In addition, the Input Signal Processing Unit 130, the Output Signal Processing Unit 124, and the Control Unit 110 are respectively equipped with Memories 135, Memory 125, and Memory 111.

Furthermore, in the present invention, White Board W is utilized as the object of projection. Such White Board W is installed so that a distance exists between it and the walls, etc. behind it. However, the object of projection of the present invention is not limited to such White Board W; it can be another object of projection, as long as it is installed with a distance existing between it and the walls, etc. behind it.

Incidentally, in the Projector 100, when image signals are input through the Image Input Connector 103 from the outside, the Signal Type Detection Unit 105 detects the type and aspect ratio of the image signals which have been input. When the image signals are analogue signals, they are converted into digital signals by the A/D Conversion Unit 104, and are subsequently input in the Input Signal Processing Unit 130.

The Input Signal Processing Unit 130 temporarily records the input image signals in the Memory 135, converts the recorded image signals into a predetermined format which can be processed by the Control Unit 110 according to the request issued by the Control Unit 110, and outputs the signals to Control Unit 110. The Control Unit 110 retrieves the image signals from the Memory 135 and outputs the retrieved signals to the Output Signal Processing Unit 124, based on the instruction from the user input through the Key Input Unit 101 and the Remote Control Input Unit 102. Moreover, the Control Unit 110 controls various types of image processing (stated later) and Zoom Lens Drive Unit 121, in order to conduct zoom adjustment.

The Output Signal Processing Unit 124 temporarily records the image signals which have been output from the Control Unit 110 in the Memory 125, converts the recorded image signals into a predetermined format which can be processed by the Image Display Unit 123, and outputs the signals to the Image Display Unit 123. This Image Display Unit 123 corresponds to a liquid crystal panel and optical system consisting of a lamp, an optical lens, etc. and outputs the input image signals as the image light. The image light output from the Image Display Unit 123 is projected onto the White Board W through the Projection Zoom Lens 120. At this time, the Projection Zoom Lens 120 zooms on the size of the projection region, either towards the telescopic side or towards the wide-angle side.

When the projected image light is reflected on the region accommodated within the White Board W of the projection region (hereafter, referred to as the “reflection region”), the projected image is seen by the users in a manner in which it is displayed in the reflection region.

Moreover, White Board W, onto which the projected image is displayed, is projected by the Imaging Unit 131. The Imaging Unit 131 corresponds to a so-called CCD camera, and its facing direction is adjusted to the projector body in a manner so that, at a minimum, the projection region is projected.

Moreover, the imaged image obtained through imaging is displayed by digitalized image signals (pixel values). In addition, the image signals are input into the Input Signal Processing Unit 130. The Input Signal Processing Unit 130, similar to the above-stated explanation, temporarily records the image signals in the Memory 135, converts the recorded image signals into a predetermined format according to the request issued by the Control Unit 110, and outputs the signals to the Control Unit 110. Furthermore, in the following, the above-stated pixel values include the degree of brightness.

The following is a specific explanation of the Projection Zoom Lens 120, the Zoom Lens Drive Unit 121, and the Zoom Lens Position Detection Unit 122, which operate in a characteristic manner in the present invention.

The Zoom Lens Drive Unit 121 drives the Projection Zoom Lens 120 in the forward and backward directions. At this time, because the focal distance changes as the position of the Projection Zoom Lens 120 changes, the projection region of the image light is zoomed towards either the telescopic side or the wide-angle side. Moreover, as the projection region changes in the zooming direction, the size of the reflection region on White Board W is reduced or enlarged, with the size of the White Board as the limit.

The position of the Projection Zoom Lens 120 is detected and quantified by the Zoom Lens Position Detection Unit 122. Specifically, the Zoom Lens Position Detection Unit 122 is equipped with variable resistance, which varies the resistance synchronized with the drive of the Projection Zoom Lens 120 and an A/D converter, and which connects the position of the Projection Zoom Lens 120 to the digitalized resistance values (hereafter, the “zoom encoder values”) in a one-to-one corresponding relationship. Therefore, the Zoom Lens Position Detection Unit 122 is capable of quantifying the position of the Projection Zoom Lens 120 as the zoom encoder value.

The Zoom Lens Position Detection Unit 122 outputs the zoom encoder value to the Control Unit 110. The Control Unit 110 records the zoom encoder value in the Memory 111, and concurrently controls the Zoom Lens Drive Unit 121 in a manner so that the input zoom encoder value becomes the desired zoom encoder value. The Zoom Lens Drive Unit 121, as stated above, drives the Projection Zoom Lens 120 in the forward and the backward directions. The position of the Projection Zoom Lens 120, after it is being driven, is again detected by the Zoom Lens Position Detection Unit 122, and is input into the Control Unit 110 as the current zoom encoder value. Moreover, by repeating such actions, the current zoom encoder value reaches the desired zoom encoder value, and the projection region is zoomed so as to be the desired size. In addition, along with this action, the size of the reflection region ion White Board W becomes the desired size.

According to the following explanation, the above-stated repeated actions by the Control Unit 110, the Zoom Lens Drive Unit 121, the Projection Zoom Lens 120, and the Zoom Lens Position Detection Unit 122 are referred to as “feedback actions.”

Furthermore, the zoom encoder value becomes zero when the projection region is zoomed to the telescopic side at the maximum degree, and becomes 255 when it is zoomed to the wide-angle side to the maximum degree.

Moreover, when the Projection Zoom Lens 120 is driven by a step motor, the position of the Projection Zoom Lens 120 can be quantified utilizing a motor step value instead of the zoom encoder value, and the feedback actions can be conducted based on the motor step values.

A1-2. Specific Actions of the Zoom Adjustment

The present invention functions to conduct an automatic zoom adjustment in a manner in which the projection region is accommodated within the object of projection, and the projected image displayed onto the object of projection, namely the reflection region, is rendered sufficiently large for the object of projection. Herein, as the zoom adjustment, two types of zoom adjustments can be considered: a zoom adjustment for which the purpose is to ensure accommodation of the project region within the object of projection solely by means of zoom adjustment; and a zoom adjustment for which the purpose is to render the reflection region sufficiently large for the object of projection in consideration of keystone correction. The latter zoom adjustment is mentioned later. First of all, the specific actions of the zoom adjustment for which the purpose is to ensure accommodation of the project region within the object of projection solely by means of zoom adjustment are explained below, utilizing FIG. 1 to FIG. 3 as references.

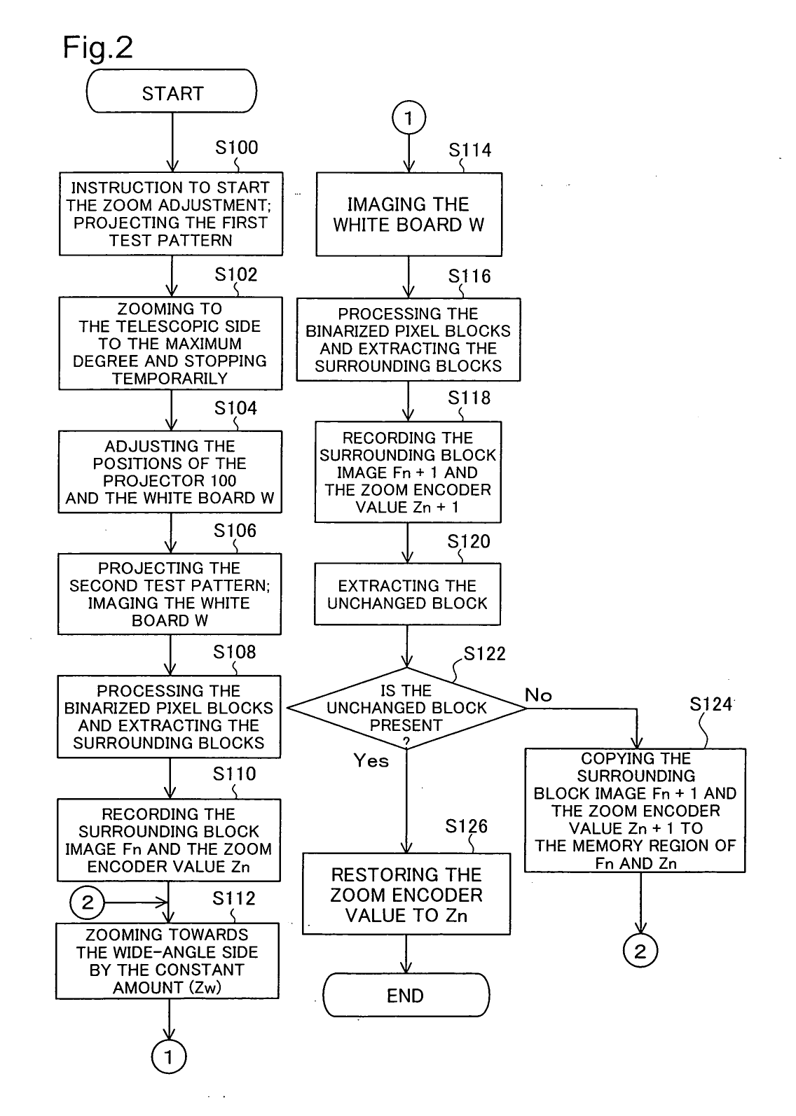

FIG. 2 is a flow chart showing the zoom adjustment procedures in the present embodiment. Although the Projector 100 projects the image light from the right front direction to the White Board W in the following explanation, the present invention is not limited by the projection direction of the image light, and can be applied to projections from directions other than from the right front direction to White Board W (so-to-speak, “high-angle projection”).

First of all, when the instructions from the user to initiate zoom adjustment are input into the Control Unit 110 through the Key Input Unit 101 and the Remote Control Input Unit 102, both shown in FIG. 1, the first test pattern image which has been preliminarily recorded in the Memory 111 in the Control Unit 110 is projected onto the White Board W (Step S100). Moreover, the first test pattern image may be any image, as long as it shows the size of the projection region.

Subsequently, the feedback actions are conducted. The projection region is zoomed towards the telescopic side to the maximum degree, and the corresponding zoom adjustment is temporarily stopped (Step S102).

The user confirms that Step S102 has been completed through the Key Input Unit 101, the Remote Control Input Unit 102, and the lighting of a lamp (omitted in the figures) equipped in the body of the Projector 100; subsequently, the user adjusts the positions of the Projector 100 and the White Board W in a manner so that the projection region, when zoomed towards the telescopic side to the maximum degree, can be accommodated within the White Board W (Step S104). In addition, even at this time, the first test pattern image is still continuously being projected onto the White Board W, which assists the adjustment of the positions.

Subsequently, when the instructions from the user to resume zoom adjustment are input into the Control Unit 110 through the Key Input Unit 101 and the Remote Control Input Unit 102, the first test pattern image, which has been projected until that time, is replaced with the second test pattern image, and the second test pattern image is projected onto the White Board W. The Imaging Unit 131 images the White Board W at this time (Step S106).

The second test pattern image is selected by the user according to the aspect ratio of the image projected after the zoom adjustment, from among several images, the aspect ratios of which have been modified to be 4:3, 16:9, etc. Subsequently the user also instructs which image should be projected when giving the instructions to resume zoom adjustment. In addition, the second test pattern image may be any image, as long as its size is the same as that of the image projected after zoom adjustment. In the following explanation, this is a white square image.

Subsequently, the image signals of the imaged image are recorded in the Memory 135 in the Input Signal Processing Unit 130.

Furthermore, the Imaging Unit 131, as stated previously, has been adjusted in terms of its facing direction in a manner so that it images, at a minimum, the projection region; therefore, the imaged image contains, at a minimum, the projection region.

Subsequently, the Control Unit 110 retrieves from the Memory 135 the image signals recorded in the Step S106, and conducts binary pixel block treatment and surrounding block extraction treatment (Step S108). These treatments are explained as follows.

The binary pixel block treatment, first of all, determines whether or not the brightness of each pixel in the imaged image exceeds the predetermined threshold level of brightness. When the level of brightness is higher than the threshold level, the corresponding pixel is replaced with 1 (white); on the other hand, when it is lower than the threshold level, the corresponding pixel is replaced with 0 (black). Subsequently, the imaged image is divided into several blocks. If the number of the white pixels present within a block is more than the number of black pixels, the entire portion of the corresponding block is made white. On the other hand, if the number of white pixels present within a block is fewer than the number of black pixels, the entire portion of the corresponding block is made black. Consequently, only the reflection region appearing within the imaged image appears as a collection of white blocks.

The surrounding block extraction treatment functions to extract the contour of the reflection region in the image to which binary pixel block treatment has been conducted; namely, the blocks corresponding to the contour of the white block collection stated above. Specifically, the present treatment thoroughly examines all of the blocks in the image to which binary pixel block treatment has been conducted. In the case in which the blocks in the four directions (up, down, left, and right) adjacent to the white block are all white, the contour is eventually extracted as a white block by replacing the corresponding white block with a black one. Furthermore, in this case, instead of the four directions stated above, the adjacent blocks in eight directions may be thoroughly examined to determine whether they are all white.

In the following, the image signals (hereafter, referred to simply as the “image”) obtained through the surrounding block extraction treatment when Zoom Encoder Value=Zn is expressed as Surrounding Block Image Fn, and the series of white blocks corresponding to the contour of the reflection region which have been extracted through the surrounding block extraction treatment, are expressed as Surrounding Block Hn.

Subsequently, the Control Unit 110 records the Surrounding Block Image Fn and the Zoom Encoder Value Zn obtained in the Step S108 in the Memory 111 (Step S110).

Subsequently, the feedback actions are conducted in a manner so that Zoom Encoder Value Zn becomes a value zoomed towards the wide-angle side by the Constant Amount Zw (Step S112). The Constant Amount Zw of the Zoom Encoder Value Zn has been predetermined and recorded in the Memory 111. In addition, the Constant Amount Zw is retrieved from the Control Unit 110, and the feedback actions are conducted in a manner so that the current Zoom Encoder Value Zn becomes Zn+Zw. Moreover, in the following, Zoom Encoder Value Zn becomes Zn+Zw is expressed as Zoom Encoder Value Zn becomes Zn+1.

Furthermore, as shown in FIG. 2, the steps from the Step S112 to the Step S124 may be repeated depending on the conditions in some cases. However, when the Step S112 is conducted at the beginning, the Zoom Encoder Value Zn is set at zero (closest to the telescopic side), as stated above.

Subsequently, in the state in which the zoom encoder value becomes Zn+1, the Imaging Unit 131 re-images the White Board W (Step S114). The image signals of the imaged image are recorded in the Memory 135.

Subsequently, the Control Unit 110 retrieves the image signals which have been recorded in the Memory 135 in the Step S114, and conducts binary pixel block treatment and the surrounding block extraction treatment (Step S116) based on the image signals. The Step S116 is the identical process to the Step S108; therefore, its explanation is omitted. In addition, the Surrounding Block Image Fn+1 is obtained in the Step S116.

Subsequently, the Control Unit 110 records the Surrounding Block Image Fn+1, which has been obtained in the Step S116, and the Zoom Encoder Value Zn+1 in the Memory 111 (Step S118).

Subsequently, the Control Unit 110 executes the unchanged block extraction treatment (Step S120). The unchanged block extraction treatment functions to compare the Surrounding Block Image Fn and the Surrounding Block Image Fn+1, both recorded in Memory 111, and to extract the white blocks remaining located at the same position (hereafter, referred to as the “unchanged blocks”). In addition, at the stage when the surrounding block image has been obtained, the white blocks are only the surrounding blocks; therefore, the unchanged block extraction treatment can be the to be one which extracts the blocks corresponding to the portions between the two surrounding blocks that are matching. in the Step S120, first of all, AND treatment is conducted to the Surrounding Block Image Fn and the Surrounding Block Image Fn+1. Specifically, the present treatment compares the color of the blocks which are located at the same corresponding position between the Surrounding Block Image Fn and the Surrounding Block Image Fn+1. When both are white, the corresponding block is determined to be white, in cases other than that—in other words, in cases in which the blocks are in white-and-black or black-and-black combinations, the corresponding block is determined to be black. Subsequently, when the white block (the unchanged block) is extracted as a result of the AND treatment, the Control Unit 110 records the coordinate of the unchanged block in the Memory 111.

In addition, in the case in which the unchanged block is extracted as a result of the AND treatment, this indicates that there are matching portions in the contour portions (the surrounding blocks) of the reflection region before and after the zoom encoder values become changed. This means that the projection region has become forced out from the area of the White Board W. Details of this state are discussed later.

Subsequently, the Control Unit 110 determines whether an unchanged block is present, based on the results obtained from the Step S120 (Step S122). When it is determined that no unchanged block has been found, the step proceeds to the Step S124. When it is determined that there is an unchanged block, the step proceeds to the Step S126.

In the Step S122, when it is determined that there is no unchanged block found, the Control Unit 110 copies the Surrounding Block Image Fn+1 and the Zoom Encoder Value Zn+1 respectively to the regions where the Surrounding Block Image Fn and the Zoom Encoder Value Zn were recorded in the Memory 111 (Step S124). With this operation, the Surrounding Block Image Fn and the Zoom Encoder Value Zn are overwritten.

When the Step S124 is completed, the step returns to the Step S112. Then the steps from the Step S112 to the Step S 122 are conducted. The steps from the Step S112 to the Step S124 are repeated until it is determined that there is an unchanged block in Step S122.

On the other hand, when it is determined that there is an unchanged block in the Step S122, the Control Unit 110 controls the current zoom encoder value to shift from Zn+1 back to Zn (Step S126). The Zoom Encoder Value Zn previous to the current one has been recorded in the Memory 111 in the Step S110; therefore, the Control Unit 110 retrieves the recorded Zoom Encoder Value Zn and assigns it as the desired zoom encoder value to control feedback actions.

When the Step S126 is completed, the present zoom adjustment is stopped.

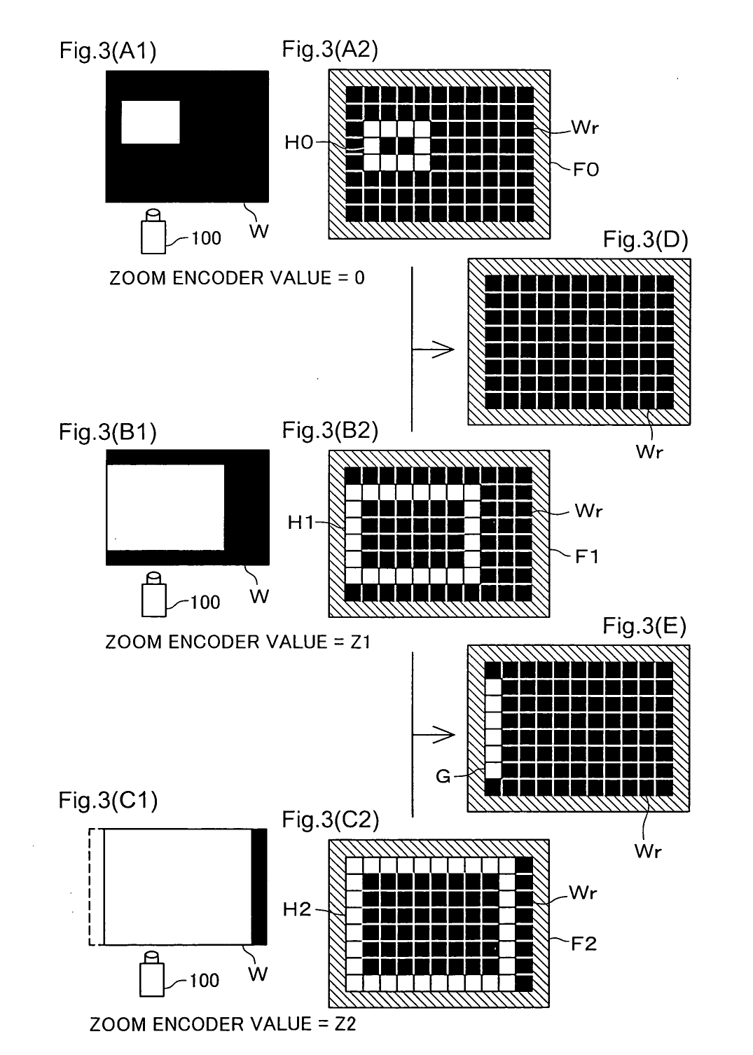

The following is a specific explanation utilizing FIG. 3. in regards to the projection region, reflection region, surrounding block image, and changes brought about to the image after the unchanged block extraction treatment at the time when actions subsequent to the Step S108 are executed.

FIGS. 3(A1) through (E) are illustrations showing the state in which the image light is projected, and the image after various treatments have been conducted to the imaged image in the present embodiment.

In FIG. 3(A1) to (C1) show the state in which the image light is projected when the zoom encoder value is respectively 0 (the initial value), Z1, and Z2 in this order in the time series; (A2) to (C2) show the Surrounding Block Images F0, F1, and F2, which are respectively obtained in the cases from (A1) to (C1); (D) shows the image after the unchanged block extraction treatment has been conducted based on the Surrounding Block Images F0, F1, and F2; and (E) shows the image after the unchanged block extraction treatment has been conducted based on the Surrounding Block Images F1 and F2.

In (A1) to (C1) in FIG. 3, the white portions on the White Board W represent the reflection regions.

In (A2) to (C2) in FIG. 3, the surrounding blocks of the Surrounding Block Images F0, F1, and F2 are represented as the Surrounding Blocks H0, H1, and H2.

Herein, as stated previously, the White Board W is installed so that a distance exists between it and the walls, etc. behind it; therefore, even if a part of the image light is projected onto the wall behind it, the reflection light from the wall is weak as compared to the reflection light from the reflection region, which renders the image displayed on the back wall dark and hard to see. Therefore, when binary pixel block treatment is conducted to the imaged image, the pixels corresponding to the wall, etc. are replaced with black. In order to make the contour of the White Board W clearer, the region corresponding to the White Board W (hereafter, referred to as “White Board Region”) Wr is shown in black, and the region corresponding to the portion behind White Board W is shown with crosshatching.

After the present zoom adjustment actions are initiated with Zoom Encoder Value Zn=0, in the Step S106, as shown in FIG. 3(A1), the second test pattern image of a white color and a square shape is projected, and the White Board W is imaged.

Subsequently, in the Step S108, as a result of conducting binary pixel block treatment and surrounding block extraction treatment, the Surrounding Block Image F0 shown in (A2) in FIG. 3 is obtained. In addition, the steps from the Steps S100 to S104 have already been executed; therefore, the projection region is accommodated within the White Board W, and the projection and reflection regions match each other. Therefore, the Surrounding Block HO corresponding to the contour of the reflection region becomes accommodated within the White Board Region Wr.

Subsequently, suppose that, in the Step S112, the zoom encoder value is shifted from 0 to Z1 towards the wide-angle side by Constant Amount Z. At this time, suppose that, as shown in (B1) in FIG. 3, the projection region and the reflection region match each other, and both are accommodated within the White Board W in a manner so that their left edges match with a part of the left edge of the White Board W. In this case, as a result of the Step S116, the Surrounding Block Image F1 shown in (B2) in FIG. 3 is obtained, while the Surrounding Block HI is accommodated within the White Board Region Wr, with the left edges matched. Then in the Step S118, the Surrounding Block Image F1 and the Zoom Encoder Value Z1 are recorded in the Memory 111.

Moreover, in the subsequent Step S120, the Surrounding Block Image F0 and Surrounding Block Image F1 are compared to conduct the AND treatment. The Surrounding Block Image F0 and Surrounding Block Image F1, as shown in (A2) and (B2) in FIG. 3, do not possess white blocks at the same position; therefore, as shown in (D), no unchanged block is extracted.

Therefore, it is determined that no unchanged block is present in the Step S122, and the step proceeds to Step S124; the Surrounding Block Image F1 is copied to the region where the Surrounding Block Image F0 is recorded in the Memory 111, and the Zoom Encoder Value Z1 is copied to the region where the Zoom Encoder Value Z0 is recorded in the Memory 111. Then the step returns to the Step S112, and the Zoom Encoder Value is further zoomed towards the wide-angle side by Constant Amount Zw to shift from Z1 to Z2. At this time, as shown by a dotted lime in (C1) in FIG. 3, the left edge of the projection region becomes forced out from the area of the White Board W.

In this case, as a result of the Step S116, the Surrounding Block Image F2 becomes as shown in (C2) in FIG. 3. Herein, as shown in (C1) in FIG. 3, the left edge of the projection region becomes forced out from the area of the White Board W, and is not reflected by White Board W; therefore, the projection region and the reflection region do not completely match each other, and the left edge of the reflection region matches not with the left edge of the projection region, but rather with the left edge of the White Board W. Therefore, the left edge of the Surrounding Block H2 corresponding to the contour of the reflection region corresponds not to the left edge of the projection region, but rather to the left edge of the White Board W. In addition, the Surrounding Block Image F2 and the Zoom Encoder Value Z2 at this time are recorded in the Memory 111 in the Step S118.

In the subsequent Step S120, the Surrounding Block Image F1 and the Surrounding Block Image F2 are compared. The left edges of the reflection regions shown in (B1) and (C1) in FIG. 3 both match with at least a part of the left edge of the White Board W; therefore, the left edge of the Surrounding Block H1 and the left edge of the Surrounding Block H2 both correspond to at least a portion of the left edge of the White Board W, which indicates a partial matching. Therefore, as a result of conducting the AND treatment to the Surrounding Block Image F1 and the Surrounding Block Image F2, as shown in (E) in FIG. 3, the Unchanged Block G is extracted at a position located at the left edge of the White Board Region Wr.

Furthermore, because the Surrounding Block H2 is larger than the Surrounding Block H1, the size of the unchanged block becomes the size of the left edge of the Surrounding Block H1.

As the unchanged block has been extracted in the Step S120, the step proceeds to the Step S126; the Zoom Encoder Value is returned from Z2 to Z1, and the zoom adjustment is stopped. As a result of the above-stated zoom adjustment, as shown in (B1) in FIG. 3, accommodation of the projection region within the White Board W is ensured.

A1-3. Effects of the First Embodiment:

As explained above, when the project region is gradually enlarged, the contours of the reflection region before and after the zoom encoder value is increased do not match with each other, as long as the projection region is accommodated within the White Board W. On the other hand, after the edge of the projection region matches a portion of the edge of White Board W, when the projection region becomes forced out from the area of the White Board W, on the border with the portion which has become un-accommodated, a part of the contour of the reflection region matches a part of the edge of the White Board W. Therefore, the contours of the reflection region before and after the zoom encoder value is increased partially match each other at the edge of the White Board W.

Therefore, on the edge of the White Board W, the blocks corresponding to the partially matching blocks are extracted as unchanged blocks. Thus, by determining whether an unchanged block is present or absent, even in the case in which there is no marker on the White Board W for indicating the edge, it becomes possible to detect that the projection region has become un-accommodated from White Board W.

Furthermore, when it is determined that there is an unchanged block, feedback actions are conducted in a manner so that the zoom encoder value becomes the previous zoom encoder value before the current one, namely, the largest zoom encoder value in the case when it is determined that there are no unchanged blocks; thus, the eventual accommodation of the projection region within the White Board W is ensured. In addition, at this time, at the position at which the projector is currently set up, the reflection region is enlarged to the maximum enlargement size possible merely by means of the present zoom adjustment.

Moreover, in the case of high-angle projection, when the vertex of the projection region, rather than the edge of the projection region, matches the edge of White Board W, followed by the further enlargement of the projection region, the projection region becomes forced out from the area of the White Board W. Even in this case, similarly to what was stated above, the blocks corresponding to the vertex of the projection region matching the edge of the White Board W are extracted as the unchanged blocks. The unchanged blocks at this time correspond to the vertex of the projection region matching the edge of the White Board W stated above.

A2. Second Embodiment:

A2-1. Purpose of the zoom adjustment:

In the present embodiment, an explanation is given regarding the zoom adjustment, the purpose of which is to render the reflection region sufficiently large for the object of projection in consideration of keystone correction.

In addition, the structure of the projector of the present embodiment is the same as that of the Projector 100 shown in FIG. 3.; therefore, its explanation is omitted. Furthermore, the test pattern images below are similar to those of the first embodiment.

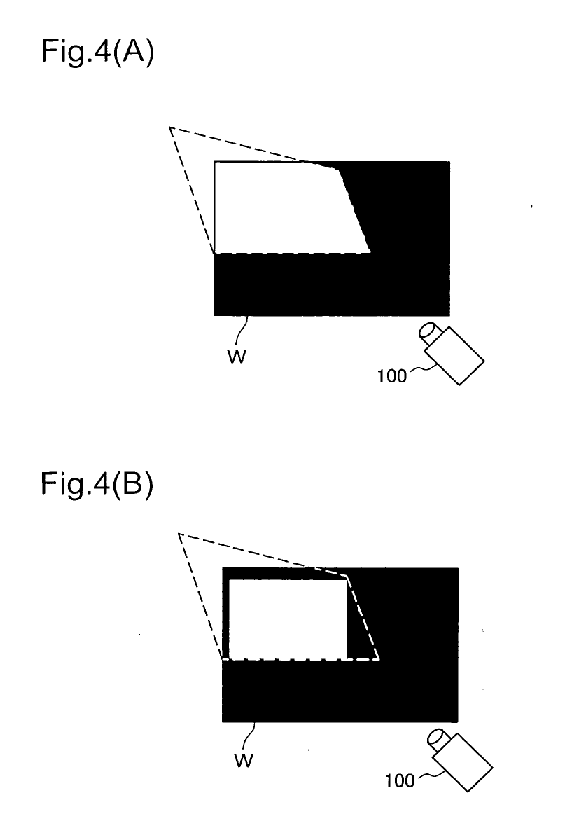

First of all, an explanation is given regarding the purpose of this zoom adjustment, utilizing FIG. 4. FIGS. 4(A) and (B) are illustrations showing the state in which the image light is projected before and after keystone correction. In FIG. 4(A) shows the state in which the image light is projected prior to keystone correction; (B) shows the state in which the image light is projected after the keystone correction in the state of (A). In FIG. 4, the projection region is shown by the dotted line frame, and the reflection region is shown by white boxes.

After the zoom adjustment, as shown in FIG. 4, the image light is projected in a manner so that the entire portion of the left side becomes completely forced out from the area of the White Board W, and a part of the projected image is not displayed on the White Board W. When keystone correction is conducted under such condition as stated above, as shown in (B) in FIG. 4, the reflection region is corrected to be a square shape, and the entire portion of the projected image is displayed onto the White Board W.

In addition, the size of the reflection region at this time has been made sufficiently large for White Board W.

The zoom adjustment of the present embodiment functions to preliminarily adjust the size of the projection region in a manner so that the entire portion of the projected image is displayed onto the White Board W, in the case in which the reflection region is corrected to be a square shape through keystone correction, by stopping the zoom adjustment at the stage when the entire portion of at least one side of the projection region becomes completely un-accommodated from White Board W.

A2-2. Specific Actions of the Zoom Adjustment:

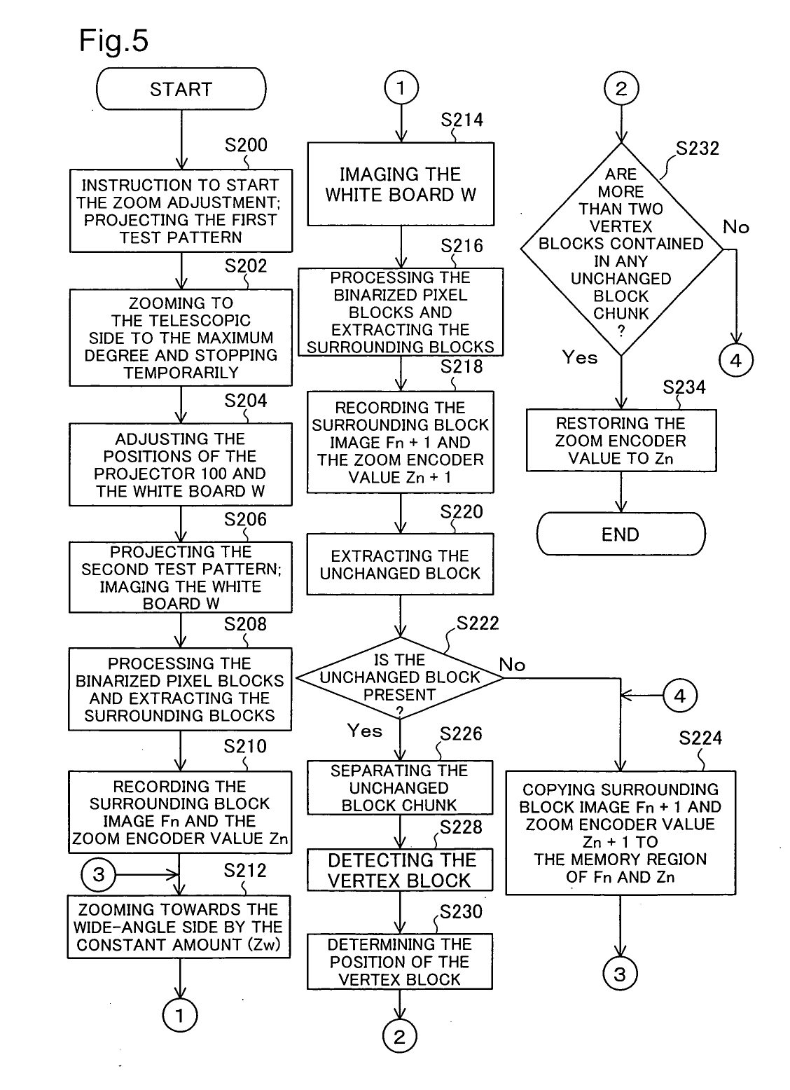

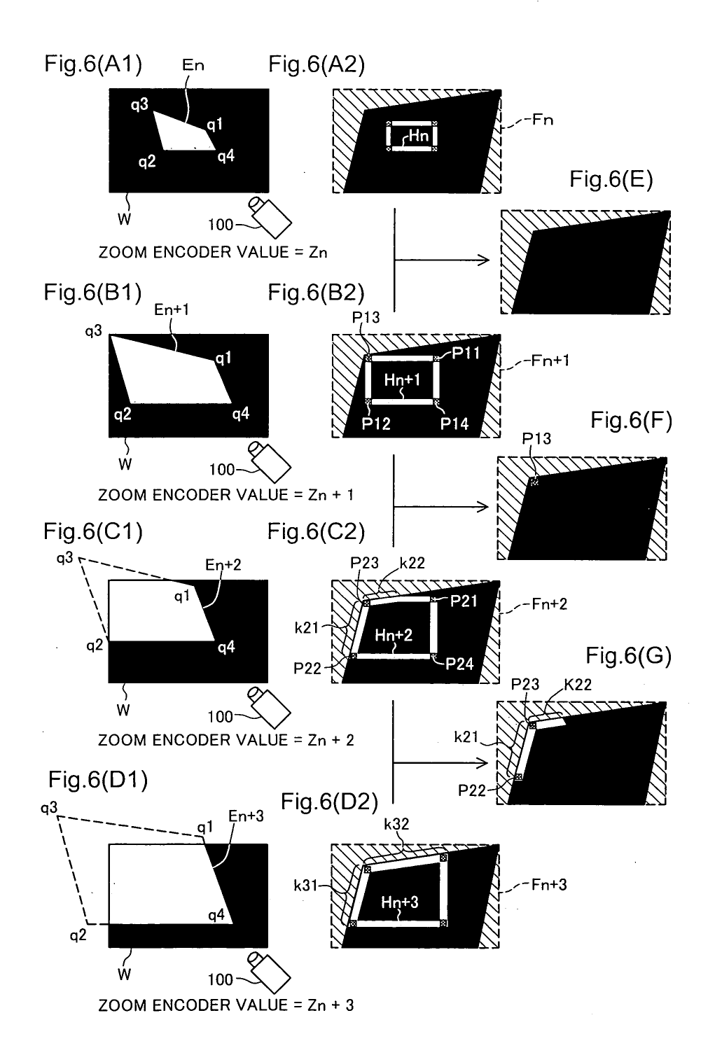

The following is an explanation given regarding the specific actions of the zoom adjustment, the purpose of which is to make the reflection region sufficiently large for the object of projection in consideration of keystone correction, utilizing FIG. 1, FIG. 5, and FIG. 6 as references.

FIG. 5 is a flow chart showing the zoom adjustment procedure in the present embodiment.

The procedures of the steps from the Step S200 to the Step S222, and the Step S224 which is executed when it is determined that there are no unchanged blocks in The Step S222, are the same as those of the steps from the Step S100 to the Step S124 shown in FIG. 2; therefore, the explanation is omitted.

On the other hand, the procedures after the Step S226, which are executed when it is determined that there is an unchanged block in the Step S222, are different from the procedures after the Step S126 shown in FIG. 2. Thus, the actions which are executed when it is determined that there is an unchanged block in the Step S222 are explained as below.

When it has been determined that there is an unchanged block in Step S222, the Control Unit 110 separates the unchanged blocks into unchanged block chunks through labeling (the Step S226). As a result of extracting the unchanged blocks in The Step S220, the extracted blocks are in several unchanged block chunks. Thus, in the Step S226, the same number (label) is given to the blocks contained in the same unchanged block chunk as the attribute, so that each of the unchanged block chunks is uniquely labeled.

Subsequently, the Control Unit 110 detects the blocks corresponding to the vertex of Surrounding Block Hn (hereafter, referred to as the “vertex blocks”), and records the coordinates of the detected vertex blocks in the Memory 111 (the Step S228). Furthermore, the following is an explanation of a case in which the vertex is utilized as an example of the feature point of the Surrounding Block Hn. However, other points may be utilized as the feature point of the Surrounding Block Hn. In addition, details of the procedure for detecting the vertex blocks are discussed later.

Subsequently, the Control Unit 110 determines which unchanged block chunk, more than two vertex blocks out of the vertex blocks detected in the Step S228, are contained in (the Step S230). The coordinates of the unchanged blocks and the vertex blocks are recorded in the Memory 111, and which unchanged block chunk each of the vertex blocks is contained in, is determined based on these coordinates.

Moreover, the Control Unit 110 totals the number of the vertex blocks contained in an unchanged block chunk, based on the results obtained from the Step S230, to determine if more than two vertex blocks are contained in which unchanged block chunk in (Step S232). In the case in which it is determined that more than two vertex blocks are contained in any of the unchanged block chunks, the step proceeds to the Step S234; on the other hand, when the number of the vertex blocks contained in all of the unchanged block chunks is either 0 or 1, the step proceeds to the Step S224.

When it is determined that more than two vertex blocks are contained in the unchanged block chunks in the Step S232, the Control Unit 110 retrieves the Zoom Encoder Value Zn from the Memory 111. Then the feedback actions are conducted in a manner so that the Zoom Encoder Value becomes shifted from Zn+1 to Zn (the Step S234).

When the Step S234 is completed, the present zoom adjustment is stopped.

The following is a specific explanation utilizing FIG. 6. in regards to the projection region, reflection region, surrounding block image, and changes brought about to the image after the unchanged block extraction treatment, at a time when the actions following the Step S214 were executed. In addition, in the following explanation, the test pattern images of a white color and a square shape are projected through high-angle projection from a right diagonal lower direction.

FIGS. 6(A1) through (G) are illustrations showing a state in which the image light is projected and the image following various treatments have been conducted to the imaged image in the present embodiment.

In FIG. 6(A1) to (D1) show the state in which the image light is projected when the zoom encoder value is respectively Zn, Zn+1, Zn +2, and Zn+3 in this order in the time series; (A2) to (D2) show the Surrounding Block Images Fn, Fn+1, Fn+2, and Fn+3, which are respectively obtained in the cases from (A1) to (D1), (E) shows the image after the unchanged block extraction treatment has been conducted, based on Surrounding Block Images Fn and Fn+1; (F) shows the image after the unchanged block extraction treatment has been conducted based on Surrounding Block Images Fn+1 and Fn+2; (G) shows the image after the unchanged block extraction treatment has been conducted, based on Surrounding Block Images Fn+2 and Fn+3.

In (A1) to (D1) in FIG. 6, the white portions on the White Board W respectively represent Reflection Regions En, En+1, En+2, and En+3; the dotted lines represent the projection regions which have become un-accommodated, from White Board W; and the four vertex of the projection region are represented by Vertexes q1 to q4. Furthermore, in (A1) and (B1) in FIG. 6, the projection region is accommodated within the White Board W; therefore, the dotted lines are omitted.

In (A2) to (D2) in FIG. 6, the surrounding blocks in the Surrounding Block Images Fn, Fn+1, Fn+2, and Fn+3 are represented as the Surrounding Blocks Hn, Hn+1, and Hn+2, and Hn+3.

In (B2), (C2), (F), and (G) in FIG. 6, P11 to P14, P21 to P24 respectively represent the vertex blocks.

Moreover, the White Board W, as stated previously, is installed so that a distance exists between it and the walls, etc. behind it. Similarly as FIG. 3, in order to make the contour of the White Board W clearer, the White Board Region is shown in black, and the region corresponding to the portion behind the White Board W is shown with crosshatching.

In the Step S214, as shown in (A1) in FIG. 6, the White Board W is imaged in a state in which the image light is projected in a manner so that the projection region is accommodated within the White Board W; subsequently, in the Step S224, the Surrounding Block Image Fn shown in (A2) in FIG. 6, as well as the Zoom Encoder Value Zn, are recorded in the Memory 111; in the Step S212, the zoom encoder value is zoomed towards the wide-angle side by Constant Amount Zw to become Zn+1. Moreover, at this time, as shown in (B1) in FIG. 6, Vertex q3 is arranged to be located upper right of the projection region so that it matches the left upper corner of the White Board W. Thus, the image light is projected in a manner so that the projection region is accommodated within the White Board W.

In the Step S214, the White Board W shown in (B1) in FIG. 6 is imaged; in the Step S218, the Surrounding Block Image Fn+1 shown in (B2) of FIG. 6, as well as the Zoom Encoder Value Zn+1, are recorded in the Memory 111.

Subsequently, the unchanged block extraction treatment is conducted in the Step S220. As shown in (A1) and (B1) in FIG. 6, under each projection state, the projection region is accommodated within the White Board W; therefore, the Reflection Region En+1 is enlarged to the size larger than the Reflection Region En, without possessing a matching contour with the Reflection Region En. Therefore, without matching between the Surrounding Block Hn and the Surrounding Block Hn+1, as shown in (E) in FIG. 6, no unchanged block is extracted.

Therefore, it is determined in the Step S222 that no unchanged block has been found, and the step proceeds to the Step S224. In the Step S224, the Surrounding Block Image Fn+1 and the Zoom Encoder Value Zn +1 are overwritten on the Surrounding Block Image Fn and the Zoom Encoder Value Zn recorded in Memory 111.

Moreover, in Step S212 again, the zoom encoder value is zoomed towards the wide-angle side by the Constant Amount Zw to become Zn+2. At this time, as shown in (C1) in FIG. 6, the image light is projected in a manner so that Vertex q2 on the left lower side of the projection region matches the left edge of the White Board W, and the entire portion of the left side of the projection region is forced out from the area of the White Board W. At this time, in the Step S214, the White Board W shown in (C2) in FIG. 6 is imaged, and in the Step S218, the Surrounding Block Images Fn +2 and the Zoom Encoder Value Zn+2 are recorded in the Memory 111.

Herein, the projection region which has become forced out from the area of the White Board W, shown by the dotted lines in (C1) in FIG. 6, is not reflected by the White Board W. Therefore, Region k21, which is located on the left side of the Surrounding Block Hn+2, and the Region k22, which is located on the upper side of the above-stated block, shown in (C2) in FIG. 6, correspond not to a part of the left edge and a part of the upper edge of the projection region, but rather to a part of the left edge and a part of the upper edge of the White Board W.

In the following Step S220, the unchanged block is detected based on the Surrounding Block Image Fn+1 and Fn+2.

The left upper corner of the Surrounding Block Hn+1 corresponds to the left upper corner of the White Board W. Furthermore, the Region k21 located on the left side of the Surrounding Block Hn+2, and the Region k22 located on the upper side of the above-stated block, as stated previously, correspond not to a part of the left edge and a part of the upper edge of the projection region, but rather to a part of the left edge and a part of the upper edge of the White Board W. Therefore, the Surrounding Block Hn+1 and Hn+2 both contain the block corresponding to the left upper corner of the White Board W. Therefore, this block is extracted as the unchanged block. At this time, Vertex q3 of the projection region En+1 has reached the unchanged block. Subsequently, in the Step S222, it is determined that the unchanged block has been detected, and the step proceeds to the Step S226. In the Step S226, the number of unchanged block chunks is determined to be one. Subsequently, in the Step S228, the Vertex Blocks from P11 to P14 of the Surrounding Block Hn+1 are detected. In the Step S230, it is determined whether the Vertex Blocks from P11 to P14 are contained within the unchanged block chunk.

The unchanged block (chunk) at this time is the block which corresponds to the left upper corner of the White Board W. Moreover, this block is, as shown in (B2) in FIG. 6, detected as the Vertex P13, located at the upper left corner of the Surrounding Block Hn+1 in the Step S228.

Therefore, in this case, only one vertex block is contained in the unchanged block chunk. Consequently, the requirements are not met in the Step S232, and the step proceeds to the Step S224. Subsequently, in the Step S224, the Surrounding Block Image Fn+2 and the Zoom Encoder Value Zn+2 are respectively overwritten on the Surrounding Block Image Fn+1 and the Zoom Encoder Value Zn+1, which have been recorded in the Memory 111.

Moreover, in the Step S212, the zoom encoder value is zoomed towards the wide-angle side by the Constant Amount Zw to become Zn+3. At this time, as shown in (D1) of FIG. 6, the image light is projected in a manner so that the Vertex q3 on the left upper side, the Vertex q2 on the left lower side, and the Vertex q1 on the right upper side of the projection region, exceed the edge of the White Board W, and the entire portion of the left side of the projection region is forced out from the area of the White Board W. At this time, in the Step S214, the White Board W shown in (D1) in FIG. 6 is imaged; in the Step S218, the Surrounding Block Images Fn+3 and the Zoom Encoder Value Zn+3 shown in (D2) in FIG. 6 are recorded in the Memory 111.

Herein, the projection region which has become forced out from the area of the White Board W, shown by the dotted lines in (D1) in FIG. 6, is not reflected by the White Board W. Therefore, the Region k31, which is located on the left side of the Surrounding Block Hn+3, and the Region k32, which is located on the upper side of the above-stated block, shown in (D2) in FIG. 6, correspond not to a part of the left edge and to a part of the upper edge of the projection region, but rather to a part of the left edge and a part of the upper edge of the White Board W.

In the following Step S220, the unchanged block is detected based on the Surrounding Block Images Fn+2 and Fn+3.

As stated previously, the Region k21 located on the left side of the Surrounding Block Hn+2, and the Region k31 located on the left side of Surrounding Block Hn+3, both correspond to a part of the left edge of the White Board W; therefore, they partially match. Furthermore, the Region k22 located on the upper side of the Surrounding Block Hn+2, and the Region k32 located on the upper side of the Surrounding Block Hn+3, likewise both correspond to a part of the upper edge of the White Board W; therefore, they partially match. Therefore, an unchanged block and an unchanged block chunk are detected in the blocks which correspond to a part of the left edge and a part of the upper edge of this White Board W.

Herein, because the projection region En+3 is zoomed more towards the wide-angle side than the projection region En+2, a comparison of the size between the Surrounding Block Hn+2 and the Surrounding Block Hn+3 finds the Surrounding Block Hn+3 to be larger than the other. Therefore, the unchanged block chunk which corresponds to the matching portion between the Surrounding Block Hn+2 and the Surrounding Block Hn+3, as shown in (G) in FIG. 6, is detected as the portion which combines the Region k21 on the left side of the smaller Surrounding Block Hn+2, and the Region k22 on the upper side of the same block.

Subsequently, in the Step S226, it is determined that what has been detected is one block chunk. In the following Step S228, the Vertex Blocks P21 to P24 of the Surrounding Blocks Hn+2 shown in FIG. 6 (C2) are detected. In the Step S230, it is determined whether the Vertex Blocks P21 to P24 are contained in the unchanged block chunk. Moreover, the Vertex Block P22 corresponds to the Vertex q2 of the projection region.

As stated above, because the unchanged block chunk shown in FIG. 6 (G) is the portion which combines the Region k21 on the left side of the Surrounding Block Hn+2 shown in (C2) in FIG. 6 and the Region k22 on the upper side of the same block, the Vertex Blocks P23 and P22 are considered to be contained in this unchanged block chunk.

Therefore, because these two vertex blocks are contained in the unchanged block chunk, the requirements are met in the following Step S232, and the step proceeds to the Step S234.

When utilizing the vertex as an example of the feature point of the projection region, as the projection region becomes enlarged, the unchanged block chunk is extended, and the vertex of the projection region becomes gradually closer to both edges of the unchanged block chunk. After the vertex of the projection region matches the edge of the White Board W, the vertex exceeds the edge of the White Board, and the entire portion of at least one side of the projection region becomes un-accommodated. Thus, the vertex of the projection region reaches at least one edge of the unchanged block chunk, and the block corresponding to the vertex becomes the vertex block. Moreover, at this time, from among the blocks which correspond either to another edge of the unchanged block chunk or to a corner of the White Board W, minimally more than one block become the vertex block. Therefore, by determining whether or not more than two vertex blocks are contained in the unchanged block chunk, the vertex of the projection region reaches the unchanged block chunk; thus, it becomes possible to determine whether or not the entire portion of at least one side has become un-accommodated. Furthermore, the block corresponding to a corner of the White Board W becomes the vertex block, when the corner of the White Board W is contained in the projection region, as shown in (C1) and (D1) in FIG. 6.

Moreover, points other than the vertex may be utilized as the feature point of the projection region.

Subsequently, in the Step S234, feedback actions are conducted in a manner so that the zoom encoder value becomes the previous zoom encoder value before the current Zn+2, which has been recorded in the Memory 111; thus, zoom adjustment is stopped. As a result of the above-stated zoom adjustment, as shown in FIG. 6 (C1), Vertex q2 on the left lower side of the projection region matches the left edge of the White Board W; thus, the entire portion of the left side of the projection region becomes forced out from the area of the White Board W.

After the above-stated zoom adjustment, as shown in FIG. 4(B), the keystone correction corrects the reflection region into a square shape, and the projected image becomes entirely displayed onto the White Board W. Moreover, the size of the reflection region becomes sufficiently large for the White Board W.

A2-3. Detailed Actions Relative to the Vertex Block Detection Treatment:

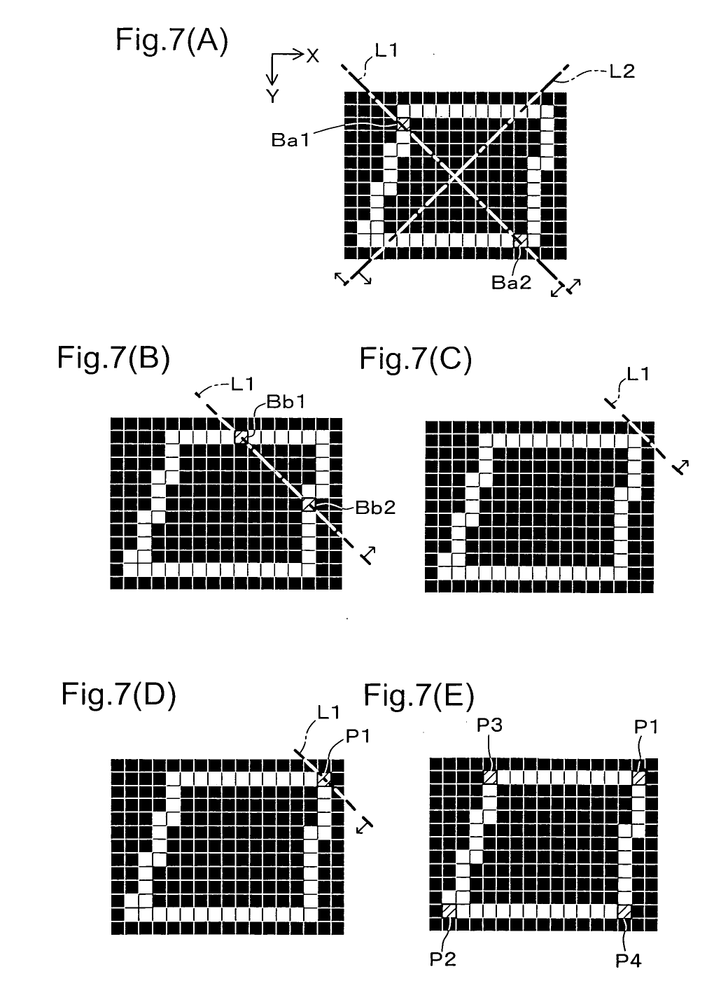

The following is an explanation of the detailed actions relative to the vertex block detection treatment, which are conducted in the Step S228, utilizing FIG. 7 as a reference.

FIGS. 7(A) through (E) are illustrations showing the vertex block detection treatment in the present embodiment. In FIG. 7(A) to (E) represent the vertex block detection treatment, in this order, in a time series.

In the vertex block detection treatment, first, a Line L1, which is represented by a chain line in FIG. 7 (A), and which forms a 45° with the X axis, (hereafter, referred to as the “Search Line”), is determined. Then, in the case in which this Search Line L1 passes through the center of the surrounding block image, the number of the white blocks on Search Line L1 is counted. At this time, as shown in FIG. 7(A), two blocks—White Blocks Ba1 and Ba2, to which hatching has been applied, are positioned on the Search Line L1; therefore, the number of white blocks counted is two.

Subsequently, the Search Line L1 is shifted towards the right upper direction, and the number of the white blocks on Search Line L1 is counted. For example, in the state shown in FIG. 7(B), the White Blocks Ba1 and Ba2, to which hatching has been applied, are positioned on the Search Line L1; therefore, the number of white blocks counted is two.

As shown in FIG. 7(C), when the Search Line L1 passes the block corresponding to the vertex of the surrounding block image, the number of white blocks on the Search Line L1 becomes zero.

At this time, the Search Line L1 is shifted backward by one, and the vertex block is determined from among the white blocks on the Search Line L1.

Specifically, for each of the white blocks on the Search Line L1 after the line is shifted backward, the brightness of the pixels contained in the block prior to conducting binary pixel block treatment is summed up, and the block with the largest summed total is determined to be the vertex block. For example, as shown in FIG. 7(D), when there is only one white block on the Search Line L1 after the line is shifted backward, the corresponding white block is determined to be the First Vertex Block P1. However, in some cases, depending on the shape of the surrounding block, there are a multiple number of white blocks on the Search Line L1 after the line is shifted backward. In this case, as stated above, one block is determined to be the vertex block from among the multiple white blocks.

Furthermore, as a result of calculating the summed-up brightness value in the manner stated above, when there are a multiple number of blocks with the largest total value, the block corresponding to the middle position is determined to be the vertex block.

Subsequently, the Search Line L1 is, at this time, shifted towards the left lower direction from the center of the surrounding block image, and the second Vertex Block P2 is detected in the same manner as stated above. Subsequently, the Search Line L2, which is represented by a chain line in FIG. 7(A) and forms a 135° with the X axis, is determined. Then the Search Line L2 is sequentially shifted from the image center to the left upper direction and the right lower direction, and the Vertex Blocks P3 and P4 are detected in the same manner as stated above, which completes the vertex block detection treatment.

After the vertex block detection treatment explained above is completed, as shown in FIG. 7(E), four Vertex Blocks from P1 to P4 of the surrounding block image are detected.

A2-4. Effects of the Second Embodiment:

As explained above, by conducting the zoom adjustment of the present embodiment, even in the case in which no edge-indicating marker is attached to the White Board W it becomes possible to determine that the unchanged block has reached the vertex of the projection region, and that the entire portion of at least one side of the image light has become forced out from the area of the White Board W, by counting the number of the vertex blocks contained in the unchanged block chunk, and by determining whether the number of the counted vertex blocks is more than two.

Furthermore, at the stage when the number of vertex blocks contained in the unchanged block chunk is determined to be more than two for the first time, feedback actions are conducted in a manner so that the zoom encoder value becomes returned to the immediately previous one, or in other words, to the zoom encoder value obtained at the time when the second vertex of the projection region matched with the edge of the White Board W, and the entire portion of at least one side of the projection region became un-accommodated from White Board W.

Therefore, by means of keystone correction following zoom adjustment, it becomes possible to adjust the size of the projection region so that the projected image becomes completely displayed onto the White Board W, while at the same time, the size of the reflection region is rendered sufficiently large for the White Board W.

B. Modification Examples

The above embodiment and its application are to be considered in all aspects as illustrative and not restrictive. There may be many modifications, changes, and alterations without departing from the scope or spirit of the main characteristics of the present invention. Some examples of possible modification are given below.

B1. Modification Example #1:

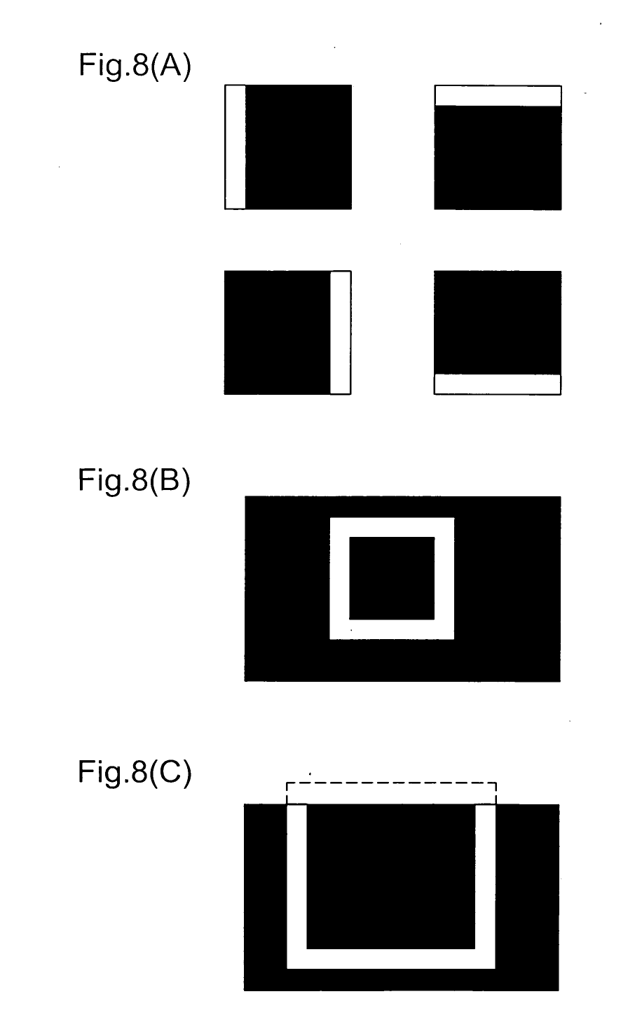

In the embodiment stated above, a white square image which is the same size as that of the image projected following zoom adjustment was utilized. However, an image which is the same size as that of the image projected following zoom adjustment, and which displays the sides of the four directions (upper, lower, left, and right) may be projected, instead of the image stated above. The following is an explanation regarding zoom adjustment at this time, utilizing FIG. 8 as the reference.

FIGS. 8(A) through (C) are illustrations showing the test pattern images and the imaged images on the white board W in the Modification Example #1. Reference numeral (A) in FIG. 8 represents four test pattern images utilized in the Modification Example #1; (B) represents the imaged image on the White Board W at the time when the test pattern images stated in (A) are projected, and (C) represents the imaged image on the White Board W at the time when the projection region becomes zoomed towards the wide-angle side by a constant amount from the state in (B).

The zoom adjustment procedure in the Modification Example #1 starts with executing the steps from the Steps S100 to S104 shown in FIG. 2. Subsequently, the Steps S106 and S108 are omitted. Substituting the Step S110, only the Zoom Encoder Value Zn at this time is recorded in the Memory 111.

Subsequently, in shifting to Step S114, the four test pattern images shown in (A) in FIG. 8 are sequentially projected, and the White Board W is imaged each time when these images are projected. In the case in which the projection region is accommodated within the White Board W, the four imaged images obtained by projection are shown in (B) in FIG. 8. Furthermore, (B) in FIG. 8 shows these four imaged images overlapping with each other.

Then, shifting to Step S116, binary pixel treatment is conducted respectively to the four obtained imaged images. This binary pixel treatment is the initial one-half treatment of the binary pixel block treatment stated previously; namely, it corresponds to the treatment which binarizes the pixels into either white or black. Subsequently, shifting to Step S118, only the zoom encoder value at this time is recorded in the Memory 111. Then, shifting to Step S120, the number of white pixels in each imaged image is counted.

Subsequently, shifting to Step S122, determination is made as to whether or not the number of counted white pixels in each imaged image is higher than that of a predetermined threshold value. At this time, in all imaged images, when the number of counted white pixels is higher than the threshold value, it is determined that the projection region has been completely accommodated within the White Board W. In addition, in this case, shifting to the Step S124, only the Zoom Encoder Value Zn+1 is copied to the region in the Memory 111 where the Zoom Encoder Value Zn has been recorded, and the step proceeds to the Step S112.

On the other hand, in any of the imaged images, if the number of counted white pixels is lower than the threshold value, as shown by the dotted lines in FIG. 8(C), it is determined that any one of the imaged images has become forced out from the area of the White Board W. Moreover, this state corresponds to the state of the above-stated embodiment in which white square test pattern images have been projected, the entire portion of any side of the projection region has become forced out from the area of the White Board W, and the entire portion of any side of the projection region does not appear in a imaged image.

Furthermore, when it is determined that any portion of the projection region has become forced out from the area of the White Board W, the step proceeds to the Step S126. After executing the Step S126, zoom adjustment is stopped.

As explained above, square images, which are the same size as that of the image projected following zoom adjustment, and which indicate the upper, lower, left, and right sides, are projected as test pattern images, and the number of white pixels in the imaged images is compared with the threshold value. Thus, it becomes possible to easily determine whether or not the entire portion of one side of the image projected following zoom adjustment is forced out from the area of the White Board W. Therefore, treatment related to this judgment can be conducted faster, and the zoom adjustment can be conducted in a short amount of time.

B2. Modification Example #2:

Furthermore, in the embodiment stated above, it is also possible to utilize images which indicate the feature points of the images projected following zoom adjustment, as the second test pattern images. Moreover, although an example in which the vertex is used as one of the examples of the feature points of the images projected following zoom adjustment is explained below, points other than the vertex point may be used as the feature point.

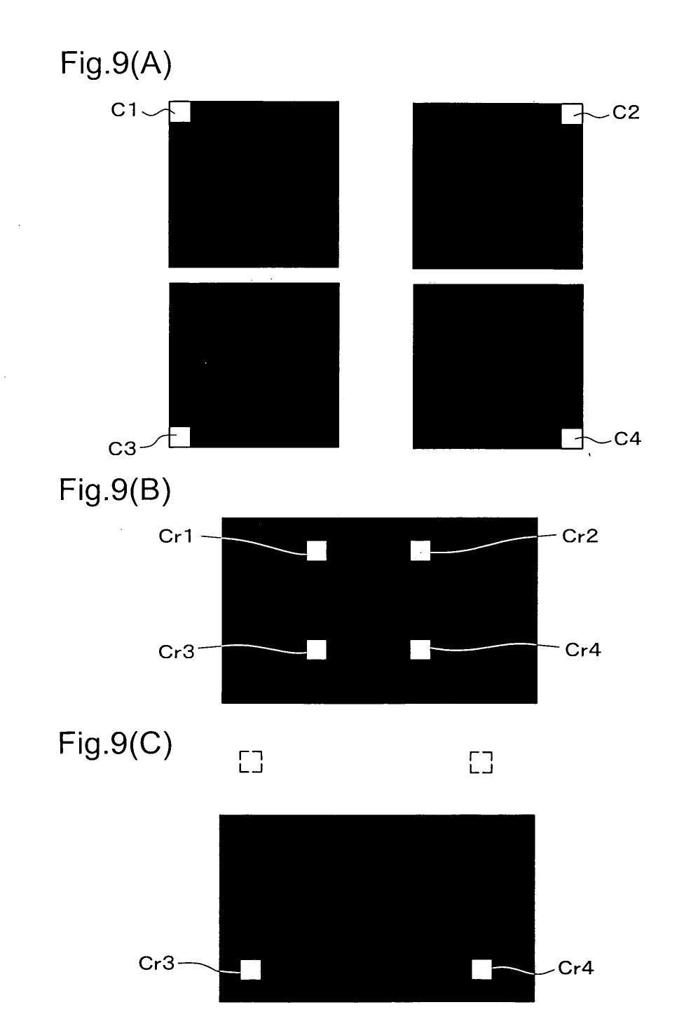

FIGS. 9(A) through (C) are illustrations showing the test pattern and the imaged images on the white board W in the Modification Example #2. The reference numeral (A) in FIG. 9 represents four test pattern images utilized in the Modification Example #2, (B) represents the imaged image on the White Board W at the time when the test pattern images stated in (A) are projected, and (C) represents the imaged image on the White Board W at the time when the projection region is zoomed towards the wide-angle side at a constant amount from the state in (B).

The zoom adjustment procedure in the Modification Example #2 starts with executing the Steps S100 to S104 shown in FIG. 2. Subsequently, the Steps and S108 are omitted. Shifting to the Step S110, only the Zoom Encoder Value Zn at this time is recorded in the Memory 111.

Subsequently, after executing the Step S112, shifting to the Step S114, as shown in FIG. 9(A), the four test pattern images which are equipped with a corner pattern at either one of the four corners are sequentially projected, and the White Board W is imaged each time when these images are projected. In the case in which the projection region is accommodated within the White Board W, the Corner Pattern Images Cr1 to Cr4 corresponding to the Corner Pattern C1 to C4 appear in the four imaged images, as shown in FIG. 9(B). Furthermore, although the imaged images are obtained four times, FIG. 9(B) shows them in an overlapping manner.

Then, shifting to the Step S116, binary pixel treatment is conducted respectively to the obtained four imaged images.

Subsequently, substituting the Step S118, only the zoom encoder value at this time is recorded in the Memory 111. Then, shifting to the Step S120, the presence or absence of white pixels in each imaged image is confirmed. In the case in which white pixels are present, it is determined that the point where the corner pattern images appear—namely, the vertex of the projection region, is accommodated within the White Board, and that such point appears within the imaged image.

Subsequently, shifting to the Step S122, the total number of corner pattern images projected within each imaged image is sought for, and determination is made as to whether or not the obtained total number is the same as the predetermined number which had been preliminarily set. For example, the predetermined number is hypothesized to be set at 4. As the size of the projection region becomes enlarged, as long as the projection region is accommodated within the White Board W, the vertexes of the projection region are all projected onto the imaged images; therefore, the total number of corner pattern images stated above becomes the predetermined number, 4. In addition, in this case, shifting to the Step S124, only the Zoom Encoder Value Zn+1 is copied to the region in the Memory 111 where the Zoom Encoder Value Zn has been recorded, and the step proceeds to Step S112.

On the other hand, when the vertex of the projection region exceeds the edge of the object of projection, and the projection region becomes forced out from the area of the White Board W, the vertex no longer appears onto the imaged images, and the total number of corner pattern images stated above becomes lower than 3. In this case, because the total number of corner pattern images does not reach the predetermined number, the step proceeds to the Step S126. For example, as shown in FIG. 9(C), when the upper side of the projection region becomes forced out from the area of the White Board W the Corner Pattern Images Cr3 and Cr4 at the lower left and lower right corners appear, so the total number of the corner pattern images becomes 2.

After the step proceeds to the Step S126, the zoom adjustment is stopped after the Step S126 is executed. Eventually, the projection region remains accommodated within the White Board W without fail.

The test pattern images can be applied to zoom adjustment, the purpose of which is to render the reflection region sufficiently large for the object of projection in regards to keystone correction, as stated in the second embodiment. In this case, the predetermined number is preliminarily set at 2.

When the first vertex of the projection region becomes forced out from the area of the White Board W, and when the second vertex matches the edge of the White Board, the entire portion of one side of the projection region becomes forced out from the area of the White Board W. The two vertexes which are un-accommodated do not appear within the imaged images. Therefore, the total number of corner pattern images stated above becomes the predetermined number, 2. At this stage, because the zoom encoder value returns to the value immediately previous to the current one, similar to the second embodiment, the size of the projection region can be adjusted in a manner so that the entire portion of one side of the projection region becomes un-accommodated.

Moreover, in the embodiment stated above, the projection region was zoomed to the maximum degree to the telescopic side in the Step S102, and zoomed to the wide-angle side in a gradual manner. Instead, the test pattern images may be utilized, and at the same time, the projection region may be designed to be zoomed to the maximum degree to the wide-angle side in the Step S102 and zoomed to the telescopic side in a gradual manner.

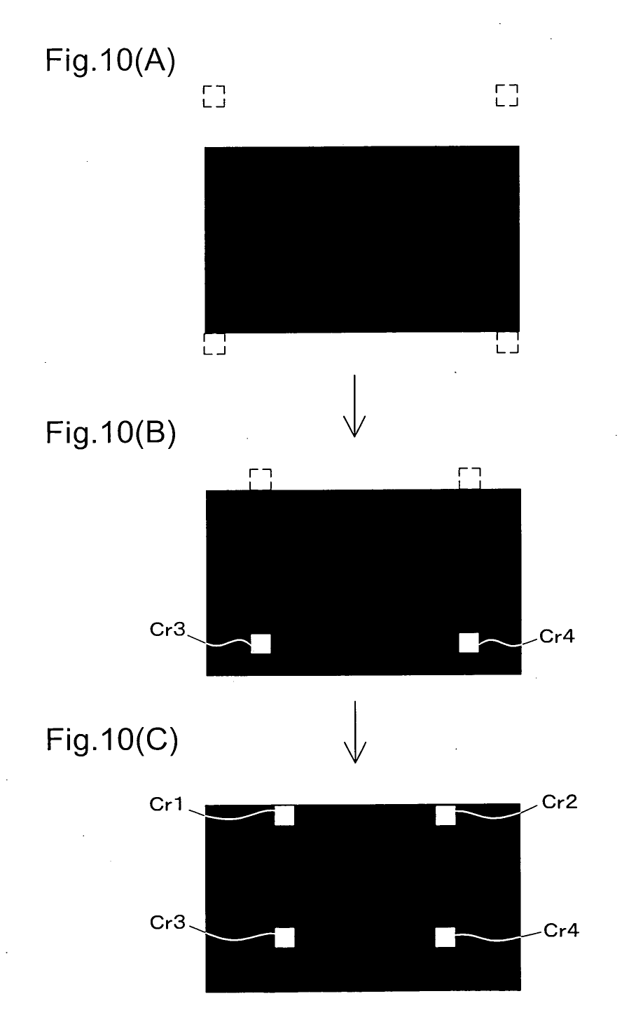

FIGS. 10(A) through (C) are illustrations showing the imaged image on the White Board W in the case of gradually zooming towards the telescopic side in the Modification Example #2. The Reference Numeral (A) in the FIG. 10 represents imaged images on the White Board W at the time when zoom adjustment is initiated, (B) represents the imaged image on the White Board W at the time when the projection region is zoomed towards the telescopic side at a constant amount from the state in (A), and (C) represents the imaged image on the White Board W at the time when the projection region is further zoomed towards the telescopic side at a constant amount from the state in (B).

The stated-above zoom adjustment zooms towards the wide-angle side in the Step S102, and concurrently adjusts the positions of the Projector 100 and the White Board W in the Step S104; thus, as shown in FIG. 10(A), all the vertexes of the projection region become forced out from the area of the White Board W. In the Step S112, feedback actions are conducted in a manner so that the zoom encoder value becomes the value zoomed towards the telescopic side by a Constant Amount Zw. Furthermore, after the Step S126 is omitted and when the total number of the corner pattern images appearing in the imaged images attains a predetermined number, zoom adjustment is stopped.

By conducting zoom adjustment in the manner stated above, for example, if the predetermined number is set at 4, as long as all the vertexes of the projection region are forced out from the area of the White Board W, the vertexes of the projection region do not appear in the imaged image. Therefore, the total number of corner pattern images becomes zero, and does not become the predetermined number. However, as the projection region gradually becomes reduced, as seen in the Corner Pattern Images Cr3 and Cr4 shown in FIG. 10(B), the vertexes of the projection region sequentially appear in the imaged images. Eventually, as shown in FIG. 10(C), the fourth vertex of the projection region matches the edge of the White Board W and the projection region is completely accommodated within the White Board W. Then, all the vertexes of the projection region appear within the imaged images, and the total number of corner pattern images becomes the predetermined number, 4. Zoom adjustment is stopped at this stage; therefore, accommodation of the projection region within the White Board W is ensured. In addition, if the predetermined number is set at 2, as shown in FIG. 10(B), similarly to the second embodiment, the size of the projection region can be adjusted in a manner so that the entire portion of one side of the projection region becomes un-accommodated.

As explained above, the images which indicate the feature points of the images projected following zoom adjustment are projected as test pattern images, and the total number of the feature points appearing in each imaged image is calculated. Thus, it becomes possible to easily determine whether or not the projection region has been accommodated within the White Board W, and whether or not the entire portion of at least one side of the projection region has become completely forced out from the area of the White Board W. Therefore, such judgments can be conducted more quickly, and zoom adjustment can be conducted in a short amount of time.

B3. Modification Example #3:

In the second embodiment stated above, as shown in FIG. 6 (C1), zoom adjustment is terminated in the following manner: the image light is projected in a manner so that the second vertex of the projection region matches the edge of the White Board W, and the entire portion of one side of the projection region becomes forced out from the area of the White Board W. However, zoom adjustment may be stopped in a manner so that the entire portion of one side of the projection region becomes forced out from the area of the White Board W immediately before the second vertex of the projection region matches the edge of the White Board W.

In this case, the procedures are arranged as follows. The Step S228 shown in FIG. 5 is omitted. In the following Step S230, instead of determining whether or not the vertex block is contained in the unchanged block chunk, the distance between the second vertex block and the unchanged block chunk is calculated by utilizing the coordinates of the unchanged block and coordinates of the vertex block recorded in the Memory 111. In the following Step S232, determination is made as to whether or not the distance calculated in the Step S230 is smaller than the predetermined value. If the calculated distance is determined to be smaller than the predetermined value, the step proceeds to the Step S234. On the other hand, if the distance is determined to be larger than the predetermined value, the step proceeds to the Step S224.

B4. Modification Example #4:

In the embodiments stated above, zoom adjustment for which the purpose is to ensure accommodation of the projection region within the object of projection merely by zoom adjustment, and zoom adjustment for which the purpose is to render the reflection region sufficiently large for the object of projection in consideration of keystone correction, were explained as different embodiments. The projector may be structured in a manner so that these two zoom adjustments can be conducted selectively.

Specifically, before executing the Step S100 shown in FIG. 2 and the Step S200 shown in FIG. 5, the user selects which zoom adjustment will be conducted. The selection result is input into the Control Unit 110 through the utilization of the Key Input Unit 101 and the Remote Control Input Unit 102 shown in FIG. 1. Subsequently, the selected zoom adjustment is conducted according to the manner stated above.

By conducting the procedures according to the manner stated above, it becomes possible for the user to select and conduct the appropriate zoom adjustment in consideration of keystone correction based on the position at which the Projector 100 is set up.

B5. Modification Example #5:

In the embodiment stated above, in the Step S126 shown in FIG. 2 and the Step S234 Shown in FIG. 5, the Zoom Encoder Value Zn recorded in the Memory 111, which is the value previous to the current one, was retrieved in order to restore the size of the projection region to the size previous to the current one, and feedback actions were conducted in a manner so that the retrieved value would be obtained. Instead of the Zoom Encoder Value Zn, the Constant Amount Zw may be retrieved from the Memory 111, the value obtained by subtracting the Constant Amount Zw from the current zoom encoder value may be calculated, and feedback actions may be conducted in a manner so as to obtain the calculated value. By conducting the procedures in this manner as stated above, it becomes unnecessary to record the current zoom encoder value in the Memory 111 each time, which contributes to reducing the cost of the projector by reducing the volume of the Memory 111, thereby speeding-up zoom adjustment by simplifying the procedures.

Furthermore, in the Step S126 shown in FIG. 2 and the Step S234 Shown in FIG. 5, instead of restoring the size of the projection region to that previous to the current one, the Constant Amount Zt, which is different from the Constant Amount Zw, may be recorded in the memory, the value obtained by subtracting the Constant Amount Zt from the current zoom encoder value may be calculated, and feedback actions may be conducted in a manner so as to obtain the calculated value. By conducting the procedures in this manner, for example, in the case in which an obstacle is present at any of the edges of the object of projection and projection needs to be conducted with the obstacle excluded, by setting the Constant Amount Zt at a level larger than the Constant Amount Zw, it becomes possible to restore the projection region towards the telescopic side by a large degree in the Steps S126 and S234; thus, zoom adjustment can be conducted in a manner so that the image light is projected with the obstacle excluded.

B6. Modification Example #6:

In the embodiment stated above, the first test pattern images were white square images; however, the images are not limited to such images. Images which have cross-shaped markers and the like in the center of a white square may also be utilized. By utilizing such images as stated above, in the Step S104 shown in FIG. 2 and the Step S204 shown in FIG. 5, the center of the projected image becomes clearer, which makes it easier for the user to adjust the positions of the Projector 100 and the White Board W.

Moreover, in the Step S100 shown in FIG. 2 and the Step S200 shown in FIG. 5, instead of first test pattern images, second test pattern images may be projected. In addition, in this case, in the Step S100 shown in FIG. 2 and the Step S200 shown in FIG. 5, from among several images, the modified aspect ratios of which are 4:3, 16:9, etc., which are recorded in the Memory 111, the user makes selections according to the aspect ratio of the images projected following zoom adjustment; and inputs into the Control Unit 110 which images have been selected. By conducting procedures in this manner, it becomes unnecessary to record the images for the first test pattern images, which contributes to reducing the cost of the projector, by reducing the volume of the Memory 111.

B7. Modification Example #7:

Depending on the type of projector, the zoom projection lens is equipped with a variable focus lens; depending on the projection direction, in some cases, the size of a portion of the projection region (for example, the part close to the lower parallel side of the projection region) does not change even after the zoom encoder value is changed.

To cope with this problem, in either one of the steps from the Steps S100 to S106 shown in FIG. 2, and the steps from the Steps S200 to S206 shown in FIG. 5, the following procedures may be conducted.

First of all, the White Board W is imaged at the time when the projection region is zoomed towards the telescopic side to the maximum degree, and the surrounding block image is extracted. Subsequently, the projection region is zoomed slightly towards the wide-angle side from the maximum telescopic side in a manner so that the projection region does not become forced out from the area of the White Board W; the White Board W at this time is imaged, and the surrounding block image is extracted. Then, from these two extracted surrounding block images, the unchanged block is extracted. The region where the unchanged block had been found is excluded from the target of treatment following the Steps S116 and S216.

By conducting procedures in this manner, it becomes possible to extract only the unchanged block, which is obtained by rendering the projection region to become forced out from the area of the White Board W, according to Steps 120 and 200, and to conduct the appropriate zoom adjustment.

B8. Modification Example #8:

In the embodiment stated above, the condition of restoring the zoom encoder value to that previous to the current one to stop zoom adjustment was, as shown in the Step S232 in FIG. 5, set to be the case in which the number of vertex blocks contained in any unchanged block chunk is higher than 2. Instead, zoom adjustment may be re-conducted from the current status of zoom adjustment, according to the user instruction to re-conduct zoom adjustment after the zoom adjustment is stopped; concurrently, the condition regarding the number of vertex blocks contained in any unchanged block chunk may be changed each time zoom adjustment is re-conducted.

Specifically, in the case of conducting initial zoom adjustment, in the Step S232 shown in FIG. 5, the step proceeds to the Step S234 when one vertex block is contained in any unchanged block chunk. Subsequently, after the initial zoom adjustment is stopped, in the case in which the user instructs to re-conduct zoom adjustment, the steps from the Steps S200 to S204 are omitted, and the second zoom adjustment is begun in Step S206. At this time, in the case in which more than two vertex blocks are contained in any unchanged block chunk in the Step S232, the step proceeds to the Step S234.

After the second zoom adjustment is stopped, when the user instructs again to re-conduct zoom adjustment, similarly to the second zoom adjustment, the third zoom adjustment is begun in the Step S206. At this time, the condition regarding the number of vertex blocks in the Step S232 is set at 3.

After the third zoom adjustment is stopped, when the user instructs again to re-conduct zoom adjustment, similarly to the second and third zoom adjustment, the fourth zoom adjustment is begun in the Step S206. At this time, the condition regarding the number of vertex blocks in the Step S 232 is set at 4.

Through conducting procedures in this manner, it becomes possible to terminate zoom adjustment, even while the projection region becomes enlarged, according to timing for determining whether or not the projection region becomes accommodated within the White Board W, by, in particular, conducting keystone correction, following the appearance of the unchanged block—namely, after the unchanged block reaches the first vertex of the projection region, according to the process in which the projection region becomes enlarged, as exemplified in cases in which the edge of the unchanged block reaches the second vertex of the projection region, and the entire portion of the first side of the projection region becomes forced out from the area of the White Board W; when the edge of the unchanged block reaches the third vertex of the projection region, and the entire portion of the second side of the projection region becomes un-accommodated from White Board W; and when the edge of the unchanged block reaches the fourth vertex of the projection region, and the entire portion of third side of the projection region becomes forced out from the area of the White Board W. Furthermore, as a result of conducting keystone correction at the time this zoom adjustment is stopped, if it is determined that there is still room for the size of the reflection region to be further enlarged for the size of the White Board W, such zoom adjustment can be re-conducted so that the projection region is further enlarged.

Therefore, zoom adjustment is conducted in a manner so that the projection region following keystone correction becomes accommodated within the White Board W, and the reflection region is rendered as large as possible for the White Board W.

Furthermore, in the case in which the zoom adjustment is stopped when the first vertex of the projection region is extracted as the unchanged block, the zoom adjustment actions are the same as those found in the first embodiment.

Moreover, although the above-stated explanation is an explanation of an example in which the vertex is utilized as one of the examples of the feature points of the projection region, other points may be used as the feature point.

Furthermore, in the case in which the Projector 100 is separately equipped with a program related to the zoom adjustment routine, and a program related to the keystone correction routine, these programs may be executed, in coordination with each other.

1. A projector for projecting image light onto an object of projection to display an image, the projector comprising:
a zoom lens capable of changing the size of the projection region onto which the image light is projected;
a drive unit for driving the zoom lens;
an imaging unit that images at least the projection region; and
a control unit;
wherein the control unit controls the drive unit to drive the zoom lens and change the size of the projection region, and
in an image obtained by imaging through means of the imaging unit, successively compares the contours of the projection region accommodated within the object of projection before and after the size of the projection region changes; extracts as unchanged portion a portion that match before and after the size change; and in the event that a feature point of the projection region reaches the unchanged portion, or the distance to the unchanged portion falls below a predetermined value, halts driving of the zoom lens so that the projection region assumes the size immediately previous.

2. The projector according to claim 1, wherein the control unit changes the size of the projection region in a manner so that the size is enlarged gradually, when changing the size of the projection region.

3. A projector for projecting image light onto an object of projection to display an image, the projector comprising:
a zoom lens capable of changing the size of the projection region onto which the image light is projected;
a drive unit for driving the zoom lens;
an imaging unit that images at least the projection region; and
a control unit;
wherein the control unit controls the drive unit to drive the zoom lens and change the size of the projection region in a manner so that the size is enlarged gradually, and
in the event that an entire portion of one side of the projection region no longer appears within an image obtained through imaging by means of the imaging unit, halts driving of the zoom lens so that the projection region assumes the size immediately previous.

4. A projector for projecting image light onto an object of projection to display an image, the projector comprising:
a zoom lens capable of changing the size of the projection region onto which the image light is projected;
a drive unit for driving the zoom lens;
an imaging unit that images at least the projection region; and
a control unit;
wherein the control unit controls the drive unit to drive the zoom lens and change the size of the projection region in a manner so that the size is enlarged gradually, and
in the event that a feature point of the projection region no longer appears within an image obtained through imaging by means of the imaging unit, halts driving of the zoom lens so that the projection region assumes the size immediately previous.

5. A projector for projecting image light onto an object of projection to display an image, the projector comprising:
a zoom lens capable of changing the size of the projection region onto which the image light is projected;
a drive unit for driving the zoom lens;
an imaging unit that images at least the projection region; and
a control unit;
wherein the control unit controls the drive unit to drive the zoom lens and change the size of the projection region in a manner so that the size is gradually reduced, and
in the event that a feature point of the projection region appears within an image obtained through imaging by means of the imaging unit, halts driving of the zoom lens.

6. A projector for projecting image light onto an object of projection to display an image, the projector comprising:
a zoom lens capable of changing the size of the projection region onto which the image light is projected;
a drive unit for driving the zoom lens;
an imaging unit that images at least the projection region; and
a control unit;
wherein the control unit controls the drive unit to drive the zoom lens and change the size of the projection region in a manner so that the size is gradually enlarged from the smallest size, and
in an image obtained through imaging by means of the imaging unit, successively compares the contours of the projection region accommodated within the object of projection before and after the size of the projection region is changed; and in the event that a portion that match before and after the size change is extracted, halts driving of the zoom lens so that the projection region assumes the size immediately previous.

7. The projector according to claim 1, wherein the feature point of the projection region is a vertex of the projection region.

8. The projector according to claim 1, wherein in the event that, of the vertexes of the projection region, a first vertex reaches the unchanged portion and a second vertex subsequently reaches the unchanged portion, the feature point of the projection region is the second vertex.

9. The projector according to claim 2, wherein the feature point of the projection region is a vertex of the projection region.

10. The projector according to claim 2, wherein in the event that, of the vertexes of the projection region, a first vertex reaches the unchanged portion and a second vertex subsequently reaches the unchanged portion, the feature point of the projection region is the second vertex.

11. The projector according to claim 4, wherein the feature point of the projection region is a vertex of the projection region.

12. The projector according to claim 4, wherein in the event that, of the vertexes of the projection region, a first vertex reaches the unchanged portion and a second vertex subsequently reaches the unchanged portion, the feature point of the projection region is the second vertex.

13. The projector according to claim 5, wherein the feature point of the projection region is a vertex of the projection region.

14. The projector according to claim 5, wherein in the event that, of the vertexes of the projection region, a first vertex reaches the unchanged portion and a second vertex subsequently reaches the unchanged portion, the feature point of the projection region is the second vertex.

15. A zoom adjustment method for a projector comprising a zoom lens capable of changing the size of the projection region onto which the image light is projected, and an imaging unit for imaging at least the projection region, the method comprising the steps of
(a) projecting the image light onto the object of projection;
(b) driving the zoom lens to change the size of the projection region;
(c) imaging the projection region;
(d) in an image obtained through imaging, sequentially comparing the contours of the projection region accommodated within the projected object of projection before and after the size of the projection region changes, and extracting portion matching before and after the size change as unchanged portion; and
(e) in the event that a feature point of the projection region reaches the unchanged portion, or the distance to the unchanged portion falls below a predetermined value, halting driving of the zoom lens so that the projection region assumes the size immediately previous.

16. The zoom adjustment method according to claim 15, wherein the step (b) involves changing the size of the projection region in a manner so that it gradually becomes enlarged, when changing the size of the projection region.

17. A zoom adjustment method for a projector comprising a zoom lens capable of changing the size of the projection region onto which the image light is projected, and an imaging unit for imaging at least the projection region, the method comprising the steps of:
(a) projecting the image light onto the object of projection;
(b) driving the zoom lens to change the size of the projection region so that the size is enlarged gradually;
(c) imaging the projection region; and
(d) in an image obtained through imaging, in the event that an entire portion of one side of the projection region no longer appears, halting drive of the zoom lens so that the projection region assumes the size immediately previous.

18. A zoom adjustment method for a projector comprising a zoom lens capable of changing the size of the projection region onto which the image light is projected, and an imaging unit for imaging at least the projection region, the method comprising the steps of:
(a) projecting the image light onto the object of projection;
(b) driving the zoom lens to change the size of the projection region so that the size is enlarged gradually;
(c) imaging the projection region; and
(d) in the event that a feature point of the projection region no longer appears within an image obtained through imaging, halting drive of the zoom lens so that the projection region assumes the size immediately previous.

19. A zoom adjustment method for a projector comprising a zoom lens capable of changing the size of the projection region onto which the image light is projected, and an imaging unit for imaging at least the projection region, the method comprising the steps of:
(a) projecting the image light onto the object of projection;
(b) driving the zoom lens to change the size of the projection region so that the size is reduced gradually;
(c) imaging the projection region; and
(d) in the event that a feature point of the projection region appears within an image obtained through imaging, halting drive of the zoom lens.

20. A zoom adjustment method for a projector comprising a zoom lens capable of changing the size of the projection region onto which the image light is projected, and an imaging unit for imaging at least the projection region, the method comprising the steps of:
(a) projecting the image light onto the object of projection;
(b) driving the zoom lens to change the size of the projection region so that the size is reduced to a minimum;
(c) driving the zoom lens to change the size of the projection region so that the size is gradually enlarged from the minimum;
(d) imaging the projection region;
(e) in an image obtained through imaging, sequentially comparing the contours of the projection region accommodated within the projected object of projection before and after the size of the projection region changes; and
(f) in the event that a portion that match before and after the size change is extracted based on a result of the comparison, halting drive of the zoom lens so that the projection region assumes the size immediately previous.

21. The zoom adjustment method according to claim 15, wherein the feature point of the projection region is a vertex of the projection region.

22. The zoom adjustment method according to claim 15, wherein in the event that, of the vertexes of the projection region, a first vertex reaches the unchanged portion and a second vertex subsequently reaches the unchanged portion, the feature point of the projection region is the second vertex.

23. The zoom adjustment method according to claim 16, wherein the feature point of the projection region is a vertex of the projection region.

24. The zoom adjustment method according to claim 16, wherein in the event that, of the vertexes of the projection region, a first vertex reaches the unchanged portion and a second vertex subsequently reaches the unchanged portion, the feature point of the projection region is the second vertex.

25. The zoom adjustment method according to claim 18, wherein the feature point of the projection region is a vertex of the projection region.

26. The zoom adjustment method according to claim 18, wherein in the event that, of the vertexes of the projection region, a first vertex reaches the unchanged portion and a second vertex subsequently reaches the unchanged portion, the feature point of the projection region is the second vertex.

27. The zoom adjustment method according to claim 19, wherein the feature point of the projection region is a vertex of the projection region.

28. The zoom adjustment method according to claim 19, wherein in the event that, of the vertexes of the projection region, a first vertex reaches the unchanged portion and a second vertex subsequently reaches the unchanged portion, the feature point of the projection region is the second vertex.
